(19) United States
(12) Patent Application Publication
(10) Pub. No.: US 2009/0232526 A1
(43) Pub. Date: Sep. 17, 2009

(54) Developer cartridge and image formation apparatus

(75) Inventors: Takuzi Yoneda, Tokyo (JP); Mugijirou Uno, Isehara-shi (JP); Kousuke Suzuki, Numazu-shi (JP); Shinichiro Yagi, Numazu-shi (JP); Masashi Nagayama, Tokyo (JP); Hitoshi Iwatsuki, Numazu-shi (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/382,477

(22) Filed: Mar. 17, 2009

(30) Foreign Application Priority Data
Mar. 17, 2008 (JP) 2008-066961
Aug. 27, 2008 (JP) 2008-217629
Nov. 7, 2008 (JP) 2008-286398
Dec. 3, 2008 (JP) 2008-308077

(51) Int. Cl. G03G 15/08

(52) U.S. Cl. 399/30

(57) ABSTRACT

A developer cartridge is provided, which contains developer made of toner and carrier and is detachably mounted in a body of an image formation apparatus. The developer cartridge is configured to include an ID chip in which a carrier content rate of the developer contained in an inner container of the developer cartridge is stored.

### CROSS REFERENCE TO RELATED APPLICATION

The present application is based on and claims priority from Japanese Patent Application No. 2008-66961, filed on Mar. 17, 2008, No. 2008-217629, filed on Aug. 27, 2008, No. 2008-286398, filed on Nov. 7, 2008 and No. 2008-308077, filed on Dec.3, 2008, the disclosure of which is hereby incorporated by reference in its entirety.

### BACKGROUND OF THE INVENTION

1. Field of the Invention

The present invention relates to an image formation apparatus such as a copier, a printer, a facsimile machine, or a complex machine of these machines and to a developer cartridge detachably provided in such an apparatus. In particular, it relates to a developer cartridge of a premix developer replenishing system which can supply a new developer to a develop unit appropriately, and to an image formation apparatus incorporating such a developer cartridge.

2. Description of the Related Art

In the prior art, it is known that a copier or a printer has a premix developer replenishing system for replenishing a develop unit containing a two-component developer made of toner and carrier with a new developer when appropriate (disclosed in Japanese Unexamined Patent Application Publication No. 2004-4559 (Reference 1), No. 2007-133057 (Reference 2), No. 2004-29306 (Reference 3), No. 2007-183348 (Reference 4), for example).

The develop unit using a two-component developer is configured to be replenished with toner appropriately according to its consumption from a toner port thereof. The toner replenished is agitated and mixed with developer in the develop unit by a carrier member such as an agitation screw or a carrier screw. Then, the mixed developer is partially supplied to a developer roller (developer carrier). Amount of the developer on the developer roller is properly restricted by a doctor blade and toner thereof is absorbed onto a latent image on a photoconductor drum.

In a general development process, carrier in the two-component developer is not consumed and remained in the develop unit so that quality of the carrier deteriorates over time. Particularly, a coating layer of carrier is abraded or peeled off by agitation and mixing of the carrier in the develop unit in a long period of time, which reduces chargeability of the carrier. Also, a spent toner in which toner components or an additive is absorbed onto the surface of the carrier causes the chargeability of the carrier to be reduced.

The premix developer replenishing system aims to prevent deterioration in image output quality due to temporal deterioration in the carrier. It makes it possible to relatively reduce the amount of deteriorated carrier and maintain the amount and chargeability of the carrier in the develop unit by appropriately supplying a new two-component developer into the develop unit and discharging a part of the developer to outside. An image formation apparatus using such premix developer replenishing system can more stably create images in good quality over time than an apparatus which needs replacement of a develop unit or carrier with a new one every time the carrier shows temporal degradation.

Reference 1, for example, discloses a develop unit using the premix developer replenishing system which comprises an overflow type developer discharge unit. This develop unit is provided with a discharge port (hole) to discharge an extraneous developer to outside when new carrier is supplied and the top surface of developer carried to the discharge port exceeds a predetermined height.

Further, Reference 4 discloses a premix developer cartridge in which a weight ratio of carrier to developer is set to 3 to 20 weight % (part by weight) in order to optimize fluidity of developer discharged from a discharge port, for example.

In the prior art there is a problem in the image formation apparatus that a variation in toner coloring degree largely affects image output qualities such as color reproducibility in a copier, a printer or the like. The coloring degree of toner varies depending on toner manufacturing condition or a change of property of toner. A variation in toner coloring degree is mainly caused by a variation in dispersibility of a binder resin of a pigment used for a coloring agent. To reduce the variation in the toner coloring degree, Japanese Unexamined Patent Application Publication No. 2003-186248 (Reference 5), No. 2004-287072 (Reference 6), No. 2006-91066 (Reference 7), Japanese Patent No. 3990214 (Reference 8) disclose techniques to improve dispersibility of a binder resin of a pigment used for a coloring agent in manufacturing toner, for example.

Also, Japanese Unexamined Patent Application Publication Nos. 2002-108147 (Reference 9) and 2002-268479 (Reference 10) disclose a developer cartridge (toner cartridge) and a develop unit which are detachably mounted in an image formation apparatus and include a data storage unit as an ID chip in which information such as a manufacture number is stored.

However, the prior art premix developer replenishing system still has a problem that when toner concentration (ratio of toner to developer) of the developer in the develop unit stays at a relatively low level, the coating layer of the carrier in the developer may be peeled off even with new carrier supplied and extraneous carrier discharged. This layer peeling-off may cause white spots in image outputs.

The inventors of the present invention have found through research and studies that the above problem is caused by a variation in the chargeability (charging characteristic) of toner due to a difference in toner manufacturing conditions (environment, manufacturing machine, property of raw materials). Specifically, toner is generally manufactured with a charge amount within standard tolerance. However, with use of a developer cartridge containing toner with an almost lower limit of charge amount in an image formation apparatus, toner concentration in a develop unit may be controlled at a relatively low level. As a result, collisions of carrier particles in developer are more likely to occur, resulting in occurrence of carrier peel-off.

In view of solving such a problem, setting a ratio of carrier in the developer cartridge to a large value in advance can be a good way to deal with toner having an almost lower limit of charge amount. However, this may cause a different problem of increases in cost, weight, and size of the developer cartridge when toner with an almost upper limit of charge amount is used and the carrier set at a high ratio becomes extraneous. Further, another way to solve the above problem is to narrow a range of the standard tolerance of the toner charge amount in manufacture process. In this case, however, yield of toner may be decreased, increasing costs of toner.

Furthermore, with regard to the variation in coloring degree of toner, even a small amount of variation may cause insufficient, unstable color reproducibility in image outputs. This is an unignorable problem considering the fact that demands for high quality images are high currently.

Further, a variation in the coloring degree of toner may greatly affect color reproducibility of image outputs especially when toner having a high coloring degree is used in order to attain high reproducibility in small amount of toner in a develop process for the sake of energy saving.

Meanwhile, the techniques disclosed in References 5 to 10 may reduce a variaiton in the toner coloring degree, however, their effects are limited in terms of toner manufacture and inspection processes.

### SUMMARY OF THE INVENTION

In view of solving the above problems, an object of the present invention is to provide a developer cartridge of a premix developer replenishing system which can prevent a carrier peel-off even when containing toner whose chargeability shows a variation in manufacture process or whose concentration in developer shows a variation, and to provide an image formation apparatus incorporating such a developer cartridge.

Another object of the present invention is to provide a developer cartridge which achieves good, stable color reproducibility of image outputs irrespective of a variation in the coloring degree of toner without increasing toner manufacture or inspection costs, and to provide an image formation apparatus incorporating such a developer cartridge.

According to one aspect of the present invention, a developer cartridge containing developer made of toner and carrier and used for an image formation apparatus is provided. The developer cartridge comprises an inner container containing the developer, and a data storage unit storing data on a content rate of the carrier in the developer contained in the inner container.

In one features of the above aspect, in a manufacture process of the developer cartridge, the content rate of the carrier is determined in accordance with a chargeability of toner to be contained in the inner container.

In the other features of the above aspect, in a manufacture process of the developer cartridge, the content rate of the carrier is set to a small value when the chargeability of the toner to be contained in the inner container is high while the content rate of the carrier is set to a large value when the chargeability of the toner is low.

In the other features of the above aspects, in the manufacture process of the developer cartridge, a chargeability of toner to be contained in the inner container is set to a chargeability of toner which is manufactured in a same manufacturing lot as the toner contained in the inner container and is mixed with carrier in a predetermined manufacturing lot other than a manufacturing lot of the carrier contained in the inner container.

In the other features of the above aspect, in the manufacture process of the developer cartridge, a chargeability of toner to be contained in the inner container is set to a chargeability of toner which is manufactured in a same manufacturing lot as the toner contained in the inner container and is mixed with carrier in a same manufacturing lot as a manufacturing lot of the carrier contained in the inner container.

According to another aspect of the present invention, an image formation apparatus comprises the above-identified developer cartridge detachably mounted in a body of an image formation apparatus; a develop unit which develops a latent image formed on an image carrier; a toner concentration detector unit which directly or indirectly detects a toner concentration of developer contained in the develop cartridge; a developer supply unit which supplies the developer from the developer cartridge to the develop unit in accordance with a result of the detection by the toner concentration detector unit; a developer discharge unit which discharges a part of the developer in the develop unit to outside; and a data read unit which reads the data stored in the data storage unit.

In one features of the above aspect, the developer supply unit changes an amount of the developer to be supplied from the developer cartridge to the develop unit in accordance with the data read by the data read unit.

In the other features of the above aspect, the developer supply unit decreases a supply of the developer when a content rate of the carrier is low and increases the supply of the developer when the content rate of the carrier is high, so as to adjust the toner concentration to be in a predetermined range.

### BRIEF DESCRIPTION OF THE DRAWINGS

FIG. 1 shows the overall structure of an image formation apparatus according to embodiments of the present invention;

FIG. 2 is a perspective view of a developer cartridge being mounted in the image formation apparatus,

FIG. 3 shows a structure of a developer supply unit;

FIG. 4 is a perspective view of the developer cartridge;

FIG. 5 shows a result of simulation for variation with time in electric resistance when a carrier content rate is changed;

FIG. 6 shows a test result of variation with time in electric resistance when a carrier content rate is changed;

FIG. 7 is a flowchart for filling a developer cartridge with developer in a manufacture process;

FIG. 8 is a flowchart for developer supply control in an image formation apparatus;

FIG. 9 shows a structure of a toner supply unit and an image generator unit;

FIG. 10 is a flowchart for toner amount control in the image formation apparatus;

FIG. 11 shows a relationship between coloring degree of toner and amount of toner absorbed; and

FIG. 12 shows the overall structure of an image formation apparatus including a develop unit integrated with a developer cartridge.

### DETAILED DESCRIPTION OF THE PREFERRED EMBODIMENT

### First Embodiment

Hereinafter, embodiments of the present invention will be described in detail with reference to the accompanying drawings. Like numerals represent like components throughout the several views and a repetitive description thereon will be simplified or avoided when appropriate.

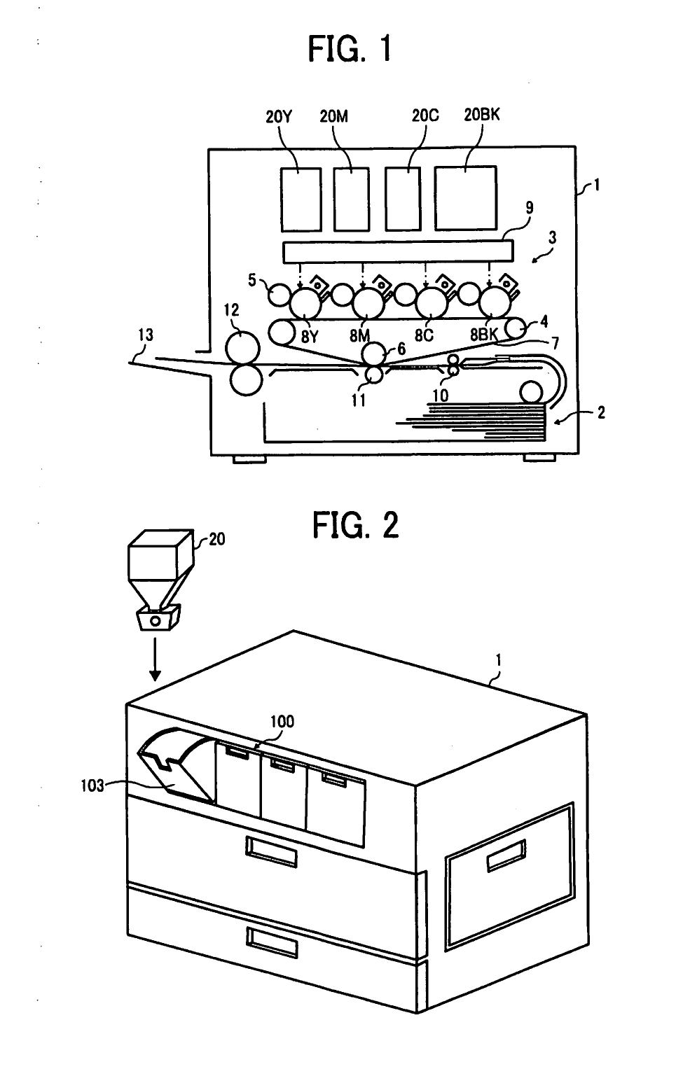

First, the overall structure and operation of an image formation apparatus according to the present embodiment is described with reference to FIGS. 1, 2. FIG. 1 shows a body 1 of an image formation apparatus (color printer) which comprises a paper feed unit 2 containing sheets of paper, an image generator unit 3 performing an image generation processing, an intermediate transfer belt (image carrier) 7 on which toner images in four colors are superimposed and transferred, rollers 4 to 6 on which the intermediate transfer belt 7 is extended and supported, photoconductor drums (image carrier) 8Y (yellow), 8M (magenta), 8C (cyan), 8BK (black) on which toner images are formed, an exposure unit (write unit) 9 emitting laser light based on image information, a resist roller pair 10 conveying sheets of paper to the intermediate transfer belt 7, a second transfer bias roller 11 transferring a toner image on the intermediate transfer belt 7 to paper, a fuser unit 12 fusing an image on the paper, a discharge tray 13 onto which sheets of paper after the fusing are discharged, and developer cartridges 20Y, 20M, 20C, 20BK containing developer in four colors (yellow, magenta, cyan, black) respectively.

The developer cartridges 20Y, 20M, 20C, 20BK contain toner in yellow, magenta, cyan, black, and carrier, respectively. They are replaced with new ones when developer therein is consumed in a develop process (later-described premix developer replenishing) and its remaining amount is almost zero. As shown in FIG. 2, the apparatus body 1 includes a container receive portion 100 partitioned into four parts into which the developer cartridges 20Y, 20M, 20C, 20BK are detachably (replaceable) placed, respectively. The four parts are provided with doors 103 to open/close for replacement of the developer cartridges 20. The structure and operation of the developer cartridges will be described in detail later.

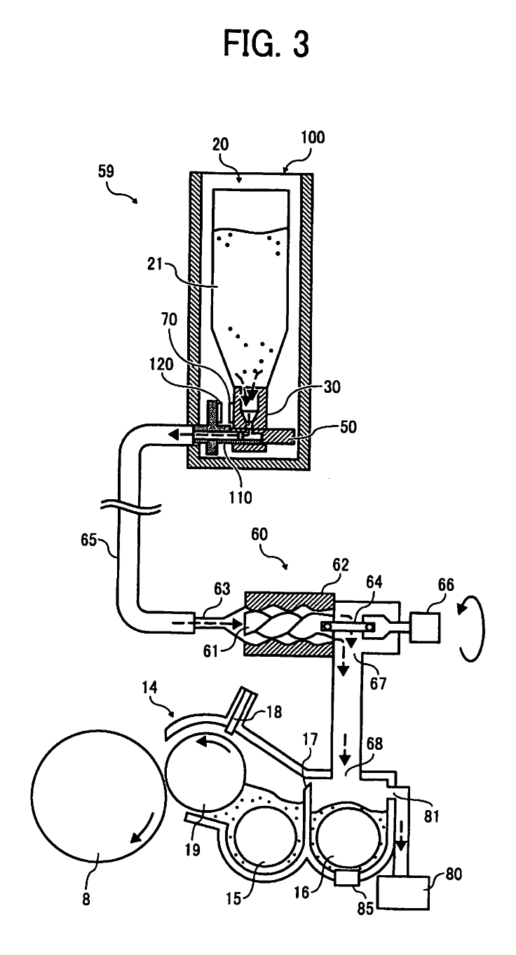

In the following, general color image generation in the image formation apparatus according to the present embodiment is described. In FIG. 1 the four photoconductor drums (8Y, 8M, 8C, 8BK) in the image generator unit 3 are rotated counterclockwise and the surfaces thereof are uniformly charged by electric chargers. Then, the charged portions of the photoconductor drums 8Y, 8M, 8C, 8BK are illuminated with laser light from the exposure unit 9 based on four color image information. Thereby, electrostatic latent images are formed on the photoconductor drums 8Y, 8M, 8C, 8BK, supplied with toners in four colors respectively, and developed by a develop unit 14 (FIG. 3).

The surfaces of the photoconductor drums 8Y, 8M, 8C, 8BK come to face the intermediate transfer belt 7 which comprises not-shown first transfer bias rollers on their inner surfaces. The developed images on the photoconductor drums 8Y, 8M, 8C, 8BK are sequentially transferred onto the intermediate transfer belt 7 by the first transfer bias rollers.

After the image transfer process, remnant toner is removed from the surfaces of the photoconductor drums 8Y, 8M, 8C, 8BK by a not-shown cleaning unit. Then, the photoconductor drums 8Y, 8M, 8C, 8BK pass through a neutralization unit, which completes a series of image generation process.

The intermediate transfer belt 7 is moved clockwise in the drawing and the full color images thereon are transferred secondarily onto paper by the second transfer bias roller 11. Remnant toner is removed from the surface of the intermediate transfer belt 7 by the cleaning unit, which completes a series of image transfer process on the intermediate transfer belt 7.

Paper is carried from the paper feed unit 2 via the resist roller pair 10 to the second transfer bias roller 11. Specifically, sheets of paper are fed from the paper feed unit 2 via a feed roller, guided to the resist roller pair 10 through a carrier guide, and carried to the second transfer bias roller 11 at a timing when the toner image on the intermediate transfer belt 7 is transferred.

Thereafter, the sheets of paper are guided to the fuser unit 12 which fuses the color toner image on the paper in a nip between a heat roller and a pressure roller, and discharged onto the discharge tray 13 via a discharge roller. This completes a series of image formation process.

Next, developer supply units 59 of the image formation apparatus will be described in detail with reference to FIG. 3. FIG. 3 shows the structure of a developer supply unit 59 seen from a back side of the apparatus body 1. The number of developer supply units 59 provided in the apparatus body 1 is four corresponding to the number of toner colors. The four developer supply units 59 have the same structure except for the toner colors, so that only one of them is shown without the alphabetic codes (Y, M, C, BK) in the drawing. Note that in FIG. 3 a part of the developer supply unit 59 is turned at 90 degrees for the sake of simplicity.

As shown in FIG. 3, the developer supply unit 59 replenishes the developer (two-component developer) in the developer cartridge 20 set in the container receive portion 100 in accordance with toner consumption in the develop unit 14. With the developer cartridge 20 set in the container receive portion 100, the developer cartridge 20 is connected to one end of a carrier pipe (nozzele) 110 provided in the container receive portion 100. By insertion of a cap member 30 into the developer cartridge 20, a plug 50 opens a toner discharge port. This delivers the developer in an inner container 21 of the developer cartridge 20 via the cap member 30 to the carrier pipe 110.

The other end of the carrier pipe 110 is connected to one end of a tube 65 which is made of a flexible rubber material with a low affinity with the toner. The other end of the tube 65 is connected to a screw pump 60 (single shafted, decentered screw pump). The screw pump 60 is comprised of a rotor 61, a stator 62, a suction port 63, a universal joint 64, a motor 66 and the like. The rotor 61 is made of a metal shaft and has a spiral groove on its outer circumference. One end thereof is rotatably coupled with the motor 66 via the universal joint 64. The stator 62 is made of a rubber material and includes a hole which has a spiral groove on its inner circumference wall. The rotor 61 is inserted into the hole of the stator 62.

Thus-configured screw pump 60 rotates the rotor 61 in the stator 62 by the motor 66 to suction the developer in the developer cartridge 20 from the suction port 63 together with air via the tube 65. The developer is suctioned from the suction port 63 to a gap between the stator 62 and the rotor 61. Along with the rotation of the rotor 61, the developer is carried from one end to the other end of the rotor 61. Emitted from the other end of the rotor 61, the developer is discharged to an exit port 67 of the screw pump 60 and supplied to the develop unit 14 via a supply port 68 (in a direction indicated by arrows in FIG. 3). According to the present embodiment, a carrier path from the developer cartridge 20 to the screw pump 60 is formed of the flexible tube 65 so that the container receive portion 100 can be disposed freely at a relatively distant position from the develop unit 14. The present embodiment uses the screw pump 60 for carrying the developer, however, the present invention is not limited thereto. A diaphragm pump or an auger screw is also usable.

The develop unit 14 is configured to include a developer roller 19 disposed to face the photoconductor drum 8, a first carrier screw 15 disposed to face the developer roller 19, a second carrier screw 16 disposed to face the first carrier screw 15 via a partition member 17, and a doctor blade 18 disposed to face the developer roller 19. The develop unit 14 contains the two-component developer of carrier and toner.

The development process in the image generating process is described in detail. The developer roller 19 is rotated in a direction indicated by an arrow in FIG. 3. The developer is circulated in the develop unit 14 in a longitudinal direction (vertical direction in the drawing) of the first and second carrier screws 15, 16 by the rotation of the first and second carrier screws 15, 16 while it is mixed and agitated with developer supplied from the developer supply unit 59 via the supply port 68. The toner is absorbed onto the carrier by a friction and attached to the surface of the developer roller 19.

The developer on the developer roller 19 is carried to the doctor blade 18, is appropriately adjusted in amount by the doctor blade 18 and then carried to a development area between the surface of the developer roller 19 and the photoconductor drum 8. In this development area, toner in the developer is attracted to an electrostatic latent image formed on the photoconductor drum 8. Specifically, the toner is attracted onto the latent image in an electric field (development field) formed by a potential difference (development potential) between a latent image potential (exposure potential) of an image portion illuminated with laser light (exposure potential) and a develop bias applied to the developer roller 19.

In the present embodiment, the developer in the developer cartridge 20 is replenished in accordance with toner consumption (variation in toner concentration) in the develop unit 14. A magnetic sensor 85 (toner concentration detector unit) of the develop unit 14 directly detects toner consumption in the develop unit 14 or a not-shown reflective photosensor (toner concentration detector unit) facing the photoconductor drum 8 indirectly detects it. The magnetic sensor 85 detects toner concentration (ratio of toner in the developer) of the developer in the develop unit 14. According to a result of the detection, a new developer containing toner at a predetermined ratio is supplied to the develop unit 14 by operating the screw pump 60 of the developer supply unit 59 for a predetermined time, so as to adjust the toner concentration to be within a predetermined range.

Now, as shown in FIG. 3, a discharge port 81 (developer discharge unit) is provided on the walls forming a carrier path around the first carrier screw 15, to discharge a part of the developer from the develop unit 14 to an external reservoir 80 outside of the carrier path. The discharge port 81 functions to discharge an extraneous developer in the develop unit 14 to the reservoir 80 when a supply from the developer supply unit 59 increases an amount of the developer to exceed the bottom end of the discharge port 81. That is, the extraneous developer is discharged over the bottom end of the discharge port 81 to drop down through a discharge path to the reservoir 80 under its own weight. As described above, the image formation apparatus according to the present embodiment adopts the above-described premix developer replenishing system so that it is able to maintain the toner concentration within a predetermined range over time and to prevent deterioration in image quality due to a variation in the toner concentration by automatically discharging, to outside of the develop unit 14, carrier degraded due to a resin as a toner material or an additive.

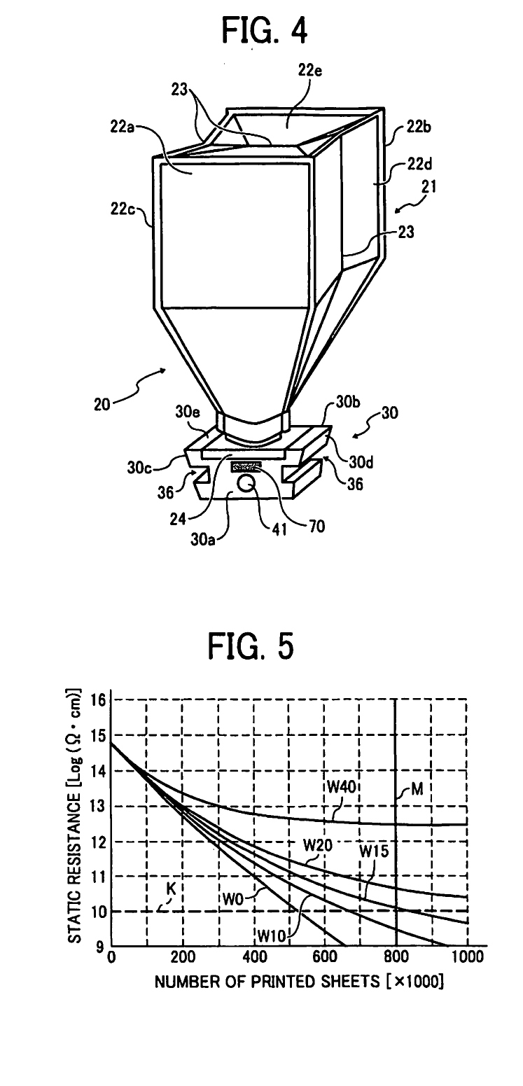

Next, the developer cartridge 20 is described in detail with reference to FIG. 4. The developer cartridge 20 in FIG. 4 is mainly composed of the inner container 21 and the cap member 30, and the inner container 21 is composed of a bag portion 22 and an adapter 24. The bag portion 22 is made of flexible sheets 22a to 22e of polyethylene, nylon and else in thickness of 80 to 200 μm by heat welding. The side sheets 22c, 22d and top sheet 22e of the bag portion 22 each include a fold line 23. The bag portion 22 can be folded compactly along the fold line 23 in accordance with a discharge of the developer from the inner container 21. Thus, in the present embodiment, the developer cartridge 20 is a deformable bag so that it is able to efficiently hold the volume of the developer therein and improve workability for replacement of the developer.

As in FIG. 4, the adapter 24 made of a resin material is fixed to an opening of the bag portion 22 by heat welding. This can secure air tightness between the bag portion 22 and the outer circumference of the adapter 24. Also, the adapter 24 is provided with an outlet port (inner through hole) to discharge the developer from the inner container 21.

The cap member 30 is detachably mounted on the adapter 24 of the inner container 21. With the cap member 30 on the inner container 21, the outlet port is brought in communication with an inlet port on the top surface 30e of the cap member 30. A discharge port 41 is provided in the cap member 30 to insert through a front face 30a to a back face 30b thereof. The cross section of the discharge port 41 is in circular form to smoothly engage with the carrier pipe 110 of the apparatus body 1 in FIG. 3. The developer is supplied from the developer cartridge 20 to the develop unit 14 while the discharge port 41 of the developer cartridge 20 is connected with the carrier pipe 110 of the apparatus body 1. Also, the cap member 30 is provided with a groove 36 which extends through side faces 30c, 30d to engage with a convex portion of the container receive portion 100 when it is mounted on the apparatus body 1.

Further, the cap member 30 of the developer cartridge 20 is configured to include an ID chip 70 (data storage unit) in which a carrier content rate of the developer in the developer cartridge 20 is stored. According to the present embodiment, the ratio of toner and carrier in the developer (carrier content rate) to be contained in the developer cartridge 20 is changed in accordance with chargeability of the toner when the developer cartridge 20 is filled with the developer in manufacture process. That is, the carrier content rate stored in the ID chip 70 is determined in the manufacture process for the developer cartridge 20 in accordance with the chargeability of the toner. Specifically, when the chargeability of the toner contained in the developer cartridge is high, the carrier content rate is set to be small while when the chargeability of the toner contained in the developer cartridge is low, the carrier content rate is set to be large. Moreover, in the present embodiment the chargeability of the tone refers to an amount of charge of toner which is manufactured in the same manufacturing lot as the toner contained in the developer cartridge 20 and mixed with carrier manufactured in a predetermined manufacturing lot. Also, the chargeability of toner can be set to an amount of charge of toner which is manufactured in the same manufacturing lot as the toner contained in the developer cartridge 20 and mixed with carrier manufactured in the same manufacturing lot as the carrier contained in the developer cartridge 20.

The developer cartridge 20 with such a structure is placed in the container receive portion 100 with the door 103 open, as shown in FIG. 2. The developer cartridge 20 is configured that in coordination with closing of the door 103, the groove 36 is engaged with the convex portion of the container receive portion 100 and the plug 50 inserted into the discharge port 41 (FIG. 3) is pushed by the carrier pipe 110 of the container receive portion 100. Thus, upon completion of setting the developer cartridge 20 in the container receive portion 100, the developer in the developer cartridge 20 is ready to be supplied to the develop unit 14 by the developer supply unit 59 (FIG. 3).

Here, the ID chip 70 of the developer cartridge 20 faces an antenna 120 (data read unit) provided in the container receive portion 100 (FIG. 3). The antenna 120 reads data on the carrier content rate stored in the ID chip 70 and transmits it to a control unit which changes an amount of developer supply from the developer cartridge 20 to the develop unit 14 according to the data. In detail, a length of time for which the screw pump 60 of the developer supply unit 59 is operated is changed with a change in the carrier content rate even when a detection result from the magnetic sensor 85 is unchanged. This enables the toner concentration of the developer in the developer cartridge 20 to be adjusted in a predetermined range irrespective of a change in the carrier content rate (or toner content rate), resulting in image outputs with a stable density. Accordingly, the developer supply unit 59 is controlled to reduce a developer supply to the develop unit 14 when the carrier content rate of the developer cartridge 20 is small and to increase the developer supply when the carrier content rate thereof is large, so that the toner concentration of the developer in the develop unit 14 is adjusted to be in the predetermined range.

Meanwhile, for detaching the developer cartridge 20 from the container receive portion 100, the above operation for setting it is performed reversely. That is, opening of the door 103 releases the carrier pipe 110 from the cap member 30 and moves the plug 50 by a bias force of a not-shown spring to a position to close the discharge port 41. Then, with the door 103 open, the developer cartridge 20 is detached from the container receive portion 100.

Note that it should be understood that in the present embodiment the data on the carrier content rate includes toner content rate of the developer in the developer cartridge 20. This is because the toner content rate is known from the carrier content rate of the developer cartridge 20.

Further, the ID chip 70 can store various kinds of data other than the carrier content rate such as toner information as toner color, developer manufacturing numbers (manufacturing lot) or dates, or recycling information as the number of times or dates of recycling or names of recycling firms. Moreover, the present embodiment is configured that the ID chip 70 of the developer cartridge 20 can communicate with the antenna 120 of the apparatus body 1 in a non-contact manner. However, it can be configured that the ID chip communicates with the antenna 120 in a contact manner. Further, the present embodiment uses the ID chip 70 as a data storage unit, however, the present invention is not limited thereto. Any known data storage device which can read and write data is usable instead of the ID chip 70.

In the following, features of the structure and operation of the image formation apparatus according to the present embodiment are described in detail. In the present embodiment an amount of charge of toner is measured in every manufacturing lot before filling the developer cartridge 20 with developer. Based on the toner charge amount, the carrier content rate (premix rate) of the developer to be filled is determined for each manufacturing lot.

The toner charge amount is measured in the following. First, 50[g] of carrier and toner with concentration of 8 [weight % (part by weight)] are mixed for a predetermined period by a ball mill S4-2 (manufactured by Ito Seisakusyo co., Ltd) at a rotation speed of 280 rpm to produce developer. Then, a part 3[g] of the developer is extracted and toner therein is dispersed on a mesh of SUS316 (interval 635) placed on a blowoff device TB-200 (by Toyo Corporation) under a condition of a flow gas of nitrogen air, blow pressure; 1.5±0.1 [kg weight/cm²], to measure charge amount Q[μC] and mass M[g] of the dispersed toner and obtain a charge amount (Q/M[−μC/g]. The carrier and toner are mixed for a period of 60 sec or 600 sec. Here, the charge amount of toner mixed for 60 sec. is referred to as TA60 while that of toner mixed for 600 seconds is referred to as TA600.

The charge characteristic of the carrier may slightly vary among manufacturing lots although the variation is small compared to toner. Carrier in a predetermined manufacturing lot is stored as measurement standard carrier and this standard carrier is used for determining standard tolerance of toner charge amount. In the present embodiment, the standard tolerance of the toner charge amount (TA60, TA600) is defined as:

35(−μC/g)≦TA60≦47(−μC/g) 26(−μC/g)≦TA600≦37(−μC/g)

TA60 mainly signifies a rising characteristic of the developer. With too low TA60, toner charge amount does not rise sufficiently for toner replenishment, causing an image output to be soiled or the toner to be splashed from the develop unit 14. In contrast, with too high TA60, a difference in the charge amounts of replenished toner and toner of the developer in the develop unit 14 will be too large immediately after replenishment so that the replenished toner with a high charge amount may push out the toner originally contained in developer when it is mixed with the developer and is charged with carrier. This also causes an image output to be soiled or the toner to be splashed from the develop unit 14.

TA600 mainly signifies a level of the charge amount at a point where developer becomes stable after sufficient agitation and mixing of toner and carrier. With too low TA600, the charge amount of the developer is generally low while with too high 600, it is generally high. Further, a too large difference in the charge amount of the developer contained in the toner develop unit 14 and TA600 causes unevenness in the charge amount of the developer, resulting in soiled images, toner splash, and density unevenness in image outputs due to nonuniform develop performance.

The present embodiment takes an adjusted toner concentration in the develop unit 14 into account to set the carrier content rate of developer (premix toner) to be contained in the developer cartridge 20 for each manufacturing lot based on a value of TA600. The relation between a value of TA 600 and the carrier content rate is as follows:

TA600=26 to 28 (−μC/g)→carrier content rate=20 weight %

TA600=29 to 33 (−μC/g)→carrier content rate=15 weight %

TA600=34 to 37 (−μC/g)→carrier content rate=10 weight %

The carrier content rate is a parameter which is adjusted according to develop condition such as the rotation speeds of the developer roller 19 and first and second carrier screws 15, 16, volume of developer, a control level of toner concentration, toner property condition such as specification of toner additives or particle shape, or carrier property condition such as specification of coating agents, coating film thickness or particle shape.

To evaluate deterioration of carrier, a degree of carrier peel-off can be estimated from a variation in electric resistance of the carrier relative to operating time of the develop unit. To obtain the electric resistance, toner is removed from the developer by a blowoff device and the resultant carrier is poured between parallel electrodes for resistance measurement (gap 2 mm) and applied with direct current of 200V. After 30 seconds elapses, a resistance is measured by a high resistance meter and converted into volume resistivity to find the carrier resistance R. In the present embodiment the target value of the carrier resistance R is set to Log R=10 (Ω·cm) or more. At Log R<10, carrier is likely to be separated from the developer roller and attached to an electrostatic latent image on the photoconductor drum when a potential difference in the develop bias applied to the developer roller and the electrostatic latent image is large, which may cause white spots in a solid image portion. Decreases in resistance occur due to the carrier peel-off so that reduction of the carrier peel-off can prevent the decreases in resistance.

FIG. 5 shows a simulation result of a variation over time in electric resistance of carrier when the carrier content rate is changed while the image formation apparatus is operated under a certain develop condition obtained by simulation. In the drawing, a horizontal axis shows the number of images (sheets) printed by the image formation apparatus and a vertical axis shows resistance values of the carrier. A curve W0 represents the carrier content rate (premix rate) being 0%, a curve W10 represents the carrier content rate being 10%, a curve W15 represents the carrier content rate being 15%, a curve W20 represents the carrier content rate being 20%, and a curve W40 represents the carrier content rate being 40%. A bold vertical line M indicates a target longevity of developer and a bold broken line K indicates a lower limit of carrier resistance. Note that the lower limit of controlled toner concentration (TC) is set to 6 weight % in the simulation of FIG. 5. The carrier content rate is determined to be a value adapted for toner concentration controlled in the image formation apparatus (controlled TC) and its control condition (TC condition) based on the simulation result in FIG. 5 and the target longevity of the developer. Then, a relation between values of TA600 and the carrier content rate is determined from a relation between the controlled TC previously acquired through a test and the TA 600 values.

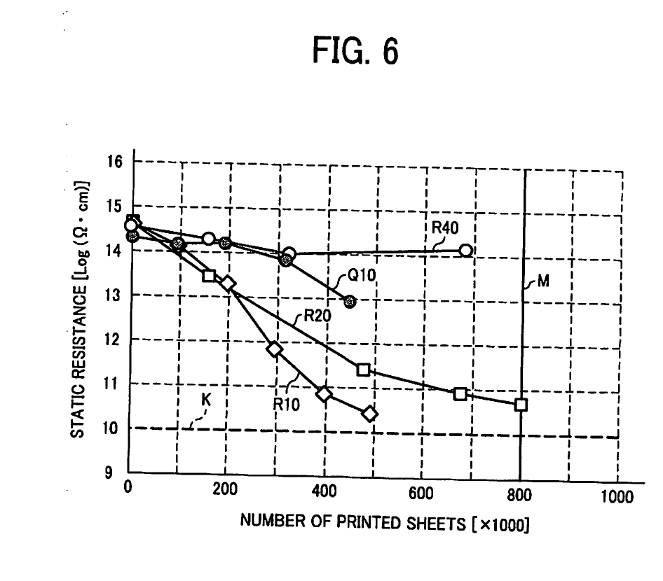

FIG. 6 shows a test result of a variation over time in electric resistance of carrier when the carrier content rate and the TA600 value are changed in the image formation apparatus according to the present embodiment. In the drawing, a horizontal axis shows the number of images (sheets) printed by the image formation apparatus and a vertical axis shows resistance values of carrier. A curve R10 represents the carrier content rate being 10% and TA 600 being 28 (−μC/g), a curve R20 represents the carrier content rate being 20% and TA 600 being 28 (−μC/g), a curve R40 represents the carrier content rate being 40% and TA 600 being 28 (−μC/g), and a curve Q10 represents the carrier content rate being 10% and TA 600 being 34 (−μC/g). A bold vertical line M indicates a target longevity of developer and a bold broken line K indicates a lower limit of carrier resistance. In the test of FIG. 6, an image area rate of an image output is set to 5% and the number of sheets printed per job is set to 5. The test result of FIG. 6 confirms that the simulation result of FIG. 5 is generally correct.

In the present embodiment, carrier in a predetermined manufacturing lot is stored as standard carrier for determining charge characteristic of a toner product (TA60, TA600 measurement). And, the carrier content rate of developer (premix toner) containing the toner is determined based on a measured TA600 value. However, another carrier in the same manufacturing lot as the standard carrier can be also used for the TA600 measurement to determine the carrier content rate. This makes it possible to more accurately measure a charge amount including very slight variation in carrier and to determine the carrier content rate based on the accurately measured charge amount.

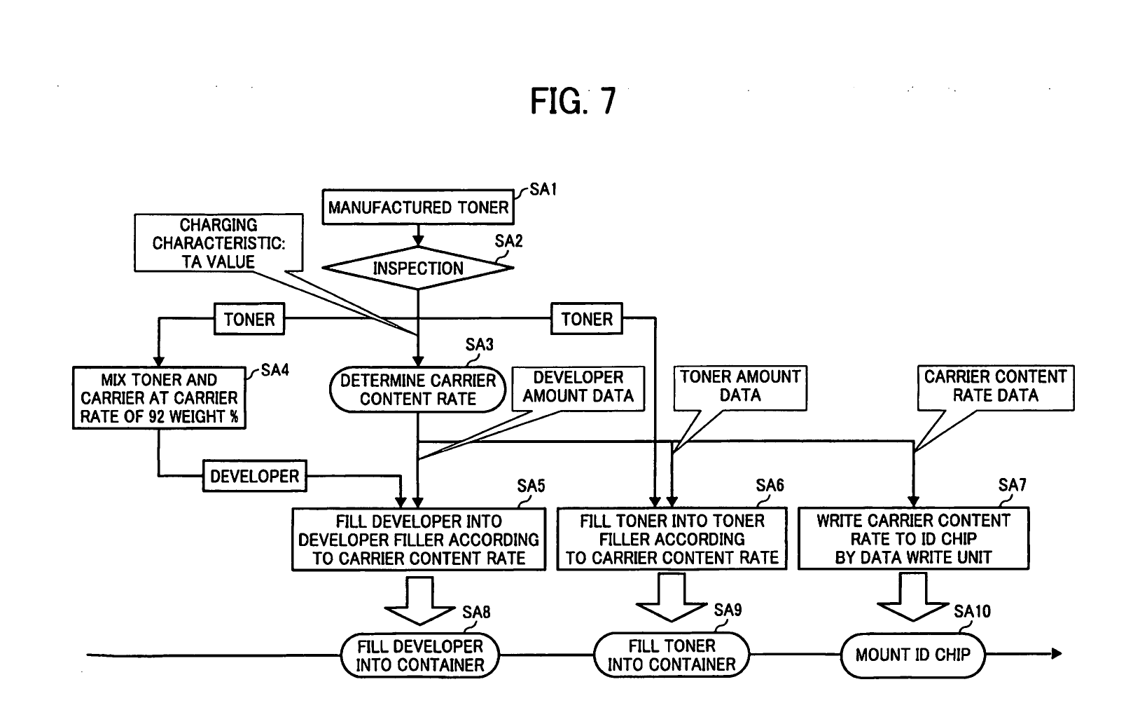

FIG. 7 is a flowchart for a process in which developer is filled into the developer cartridge 20 at manufacturing. At step SA1 toner is manufactured, and at step SA2 toner in each manufacturing lot is subjected to measurement and inspection for determining whether or not toner property is within manufacturing standard. Then, TA 600 values as property characteristic are measured to determine the carrier content rate (step SA3). Then, developer (premix toner) is filled into the developer cartridge as follows.

First, at step SA4 developer is manufactured at a predetermined carrier concentration (or toner concentration) which is set to 92 weight % in the present embodiment. This developer is manufactured in the same manner as developer preset in the develop unit at a time of shipping or one set in the develop unit after delivery. At step 5, a predetermined amount of developer with the carrier rate of 92 weight % is poured into a developer filler and then a predetermined amount of developer is additionally poured thereinto according to a target carrier content rate (Table 1). The developer filler fills a predetermined amount of developer into a developer cartridge (step SA8). The additional filling amount of developer is changed according to the carrier content rate shown in Table 1.

TABLE 1

| carrier | |
|---|---|
| concent rate | filling amount |
| (weight %) | (g) |
| 10 | 121 |
| 15 | 192 |
| 20 | 272 |

At step SA6, a predetermined amount of toner is poured into a toner filler according to a target carrier content rate. The toner filler fills a predetermined amount of toner into the developer cartridge step SA9. The predetermined amount of toner is changed according to the carrier content rate shown in Table 2.

TABLE 2

| carrier | |
|---|---|
| concent rate | filling amount |
| (weight %) | (g) |
| 10 | 992 |
| 15 | 985 |
| 20 | 979 |

As above, not filling the carrier and the toner separately into the developer cartridge but filling the premix developer and the toner thereinto makes it possible to bring all of carrier particles to be electrically bonded with toner particles in the developer cartridge. Thereby, it is possible to evenly disperse the toner in the developer cartridge.

Moreover, at step SA7, the carrier content rate determined at step SA3 is written to the ID chip 70 by a data write unit. Then, the ID chip 70 storing data on the carrier content rate is mounted on the developer cartridge 20 having been filled with the developer at step SA10.

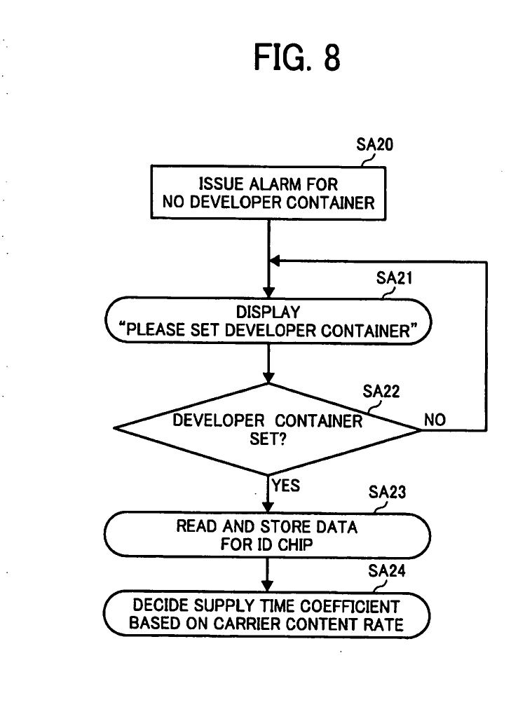

FIG. 8 is a flowchart for developer supply control in the image formation apparatus according to the present embodiment. In the drawing, at step SA20 an alarm is issued when the developer cartridge 20 is not set in the container receive portion 100 of the apparatus body 1. At step SA21, a message, “Please set developer cartridge” is displayed on a display unit of the apparatus body 1. At step SA22, a determination is made on whether the developer cartridge is set or not. With the developer cartridge still not set, the steps after SA21 are repeated. With the developer cartridge set, the antenna 120 reads and stores data on the carrier content rate stored in the ID chip 70 at step SA23.

At step 24, the developer supply unit 59 changes an amount of supply from the developer cartridge 20 to the develop unit 14 according to the read carrier content rate. Specifically, the developer supply unit 59 determines a best supply time coefficient according to the read carrier content rate. According to the present embodiment, at step SA24, the toner concentration of the developer in the develop unit 14 is adjusted to be constant by changing a correlation table of operating time of the screw pump 60 of the developer supply unit 59 and an amount of developer supply to the develop unit 14. Specifically, in the present embodiment, the supply time coefficient is set to 1 when the carrier content rate is 10%, set to 1.06 when the carrier content rate is 15%, and set to 1.13 when the carrier content rate is 20%.

Thus, by changing the carrier content rate of developer to be contained in the developer cartridge 20 according to charge amount of toner in the developer, it is possible to optimize a level of the toner concentration control over the develop unit 14 and prevent the developer from deteriorating due to carrier peel-off. Accordingly, image outputs with defects as white points are preventable. Moreover, without increasing kinds of carrier, more accurate toner charge characteristic is obtainable so that effects of the premix developer replenishing system can be achieved with use of a minimum amount of carrier. Also, even using a developer cartridge with a different carrier content rate does not affect the toner concentration of the developer in the develop unit 14, which leads to outputting images with a constant density.

Next, the developer (carrier and toner) used in the develop unit 14 according to the present embodiment is described. In the present embodiment, the carrier is of a weight-average particle size of 20 to 65 μm. This is because at the weight-average particle size less than 20 μm, evenness of particles decreases and bead carry-over is likely to occur, while at the weight-average particle size over 65 μm, reproducibility in image details deteriorates so that fine detailed images cannot be obtained. Note that the weight-average particle size of carrier is measured in a range of 0.7 μm or more to 125 μm or less by a microtrack particle size analyzer SRA type (by Nikkiso Co., Ltd.). In this measurement, methanol is used for solvent of fluid dispersion at a refractive index of 1.33. The refractive index of the carrier and a core material is set to 2.42.

The average thickness of a coating film of carrier is set to 0.05 to 4.00 μm or less (preferably, 0.05 to 1.00 μm). At the average thickness being less than 0.05 μm, the coating film is not thick sufficient to coat a convex portion of a particle so that the convex portion may be rubbed off or a core material may be exposed, reducing resistance of the carrier. At the average thickness being over 4.00 μm, chargeability of carrier deceases due to large carrier particles, causing a reduction in fineness of images.

In order to obtain fine, detailed color images, the present embodiment uses spherical polymerized toner of small particle size. The volume average particle size of the toner is 3 to 8 μm and the average circularity thereof is 0.13 to 1.00. Using such toner can increase resolution of images and transfer performance, achieving good image quality. Furthermore, an additive agent, hydrophobic silica whose primarily particle size is less than 20 nm, is added to the toner at a mass ratio (hydrophobic silica to toner) of 0.3 to 5.0 mass %. This allows fluidity of the toner of a small particle size to be maintained.

The volume average particle size of the toner can be measured with a particle distribution counter such as a Coulter counter TA-II or a Coulter multisizer II (both manufactured by Beckman Coulter, Inc.) based on a Coulter counter method. The measurement is done as follows. A surfactant (preferably, alkyl benzene sulfonates) of 0.1 to 5.0 ml is added to an electrolyctic aqueous solution of 100 to 150 ml in which about 1% NaCl aqueous solution is adjusted with a primary sodium chrolide (for example, ISOTON-II by Beckman Coulter, Inc.). Then, 2 to 20 mg of a sample is added. The aqueous solution in which the sample is suspended is dispersed for about 1 to 3 minutes by an ultrasonic distributor with an aperture of 100 μm to measure the volume of toner and the number of toner particles and calculate toner volume distribution and number distribution. The volume average particle size (D4) and number average particle size are obtained from the calculated distributions. Channels used here are 13 channels of 2.00 to 2.52 μm or less, 2.52 to 3.17 μm or less, 3.17 to 4.00 μm or less, 4.00 to 5.04 μm or less, 5.04 to 6.35 μm or less, 6.35 to 8.00 μm or less, 8.00 to 10.08 μm or less, 10.08 to 12.70 μm or less, 12.70 to 16.00 μm or less, 16.00 to 20.20 μm or less, 20.20 to 25.40 μm or less, 25.40 to 32.00 μm or less, and 32.00 to 40.30 μm or less. Toner particles of a size 2.00 μm or more and 40.30 μm or less are subjected to measurement.

Circularity A of the above toner is expressed by:

Circularity A=L₀/L

where L₀ is a boundary length of a circle with the same projected size as that of a particle image and L is a boundary length of a projected image of a particle. The circularity is an index for concavity/convexity of toner particles. A perfect spherical toner will show circularity of 1.00 and the more complex the surface shape is, the smaller the circularity is. The circularity can be measured by a flow-type particle image analyzer FPIA-2000 (manufactured by Sysmex Corporation) as follows. First, water of 100 to 150 ml without solid impurities is prepared in a container, and a surfactant agent (preferably, alkyl benzene sulfonates) of 0.1 to 0.5 ml as a dispersant and a sample of about 0.1 to 0.5 g are added to the water. The suspension fluid is dispersed by an ultrasonic distributor for about 1 to 3 minutes in concentration of 3,000 to 10,000 piece/μl to measure the shape of the toner with the above image analyzer.

Further, the toner used in the present embodiment is of a shape coefficient SF-1 of 100 to 180 and a shape coefficient SF-2 of 100 to 180. This allows an increased amount of the additive to be attached to one toner particle, thereby increasing an amount of inorganic particulates to protect the toner base surface from external stress as collision with carrier. Also, the toner contains fine toner powder of 2 μm or less at 30% or less. At content of the fine toner powder being over 30%, the number of inorganic particulates attached to one toner particle is reduced, increasing agglomeration of the toner particles, decreasing fluidity of the developer and decreasing dispersibility of the toner in the developer when replenished.

The shape coefficient SF-1 signifies a degree of roundness of toner's shape. When the shape coefficient SF-1 is 100, the toner's shape will be a perfect sphere. The larger the SF-1 is, the more unshaped the toner shape is. The SF-1 is expressed by the following equation:

SF-1={(MXLNG)²/AREA}×(100π/4)

where MXLNG is a maximum length of a toner shape projected onto a two-dimensional plane and AREA is an area of the toner shape.

The shape coefficient SF-2 signifies a ratio of concavity and convexity of the toner shape. There is no unevenness on the surface of the toner when the shape coefficient SF-2 is 100. The larger the SF-2 is, the more obvious the unevenness is. The SF-2 is expressed by the following equation:

SF-2={(PERI)²/AREA}×(100π/4)

where PERI is a circumferential length of a toner shape projected onto a two-dimensional plane and AREA is an area of the toner shape. The shape coefficients are measured, specifically, by taking a picture of the toner with a scan-type electron microscope S-800 (by Hitachi Limited) and inputting data on the picture to an image analyzer LUSEX3 (by Nireco Corporation) for analytical computation.

The toner is not limited to the above-described toner, and other known toner such as oilless toner is usable. The oilless toner contains a binder resin, a colorant and a release agent. The oilless toner can be used in the fuser unit 12 including a heat roller (fuse roller) without toner attachment preventing oil coated. Although spent toner in which a releasing agent is moved onto to a carrier surface is likely to occur in the oilless toner, the premix developer replenishing system can concurrently supply toner and carrier. Because of this, it can improve resistance to the spent toner dramatically, compared to supplying toner only, making it possible to maintain good toner quality over a long period of time.

As described above, in the present embodiment, the developer cartridge 20 is configured to include the ID chip 70 (data storage unit) in which the carrier content rate of developer to be contained is stored. This makes it possible to reliably prevent the carrier peel-off even when toner concentration of the developer in the develop unit 14 shows a variation due to a variation in the chargeability of toner in toner manufacturing process.

Moreover, the present embodiment uses a deformable bag-type developer cartridge 20. However, the present invention is not limited thereto and applicable to other types of developer cartridges such as bottle type or box type having non-deformable, rigid walls. Such other developer cartridges can attain the same effects as those of the present embodiment by including the data storage unit storing the carrier content rate of the developer.

The present embodiment adopts the develop unit in which two carrier screws are horizontally placed. However, the present invention is applicable to other develop units such as one in which two carrier screws are vertically placed, one in which three or more carrier screws are placed, or one comprising a paddle type carrying member carrying developer in a shorter direction instead of the first carrier screw 15 carrying developer in a longitudinal direction. These other develop units can attain the same effects as those in the present embodiment.

### Second Embodiment

The first embodiment has described the developer cartridge for premix developer replenishing system including the ID chip storing data on the carrier content rate. The second embodiment will describe a developer cartridge containing color toner which includes an ID chip storing data on coloring degree of toner.

Hereinafter, only a portion of the second embodiment different from the first embodiment will be described. The same or equivalent components thereof will be given the same numeric codes as those of the first embodiment, therefore, a description thereof will be omitted.

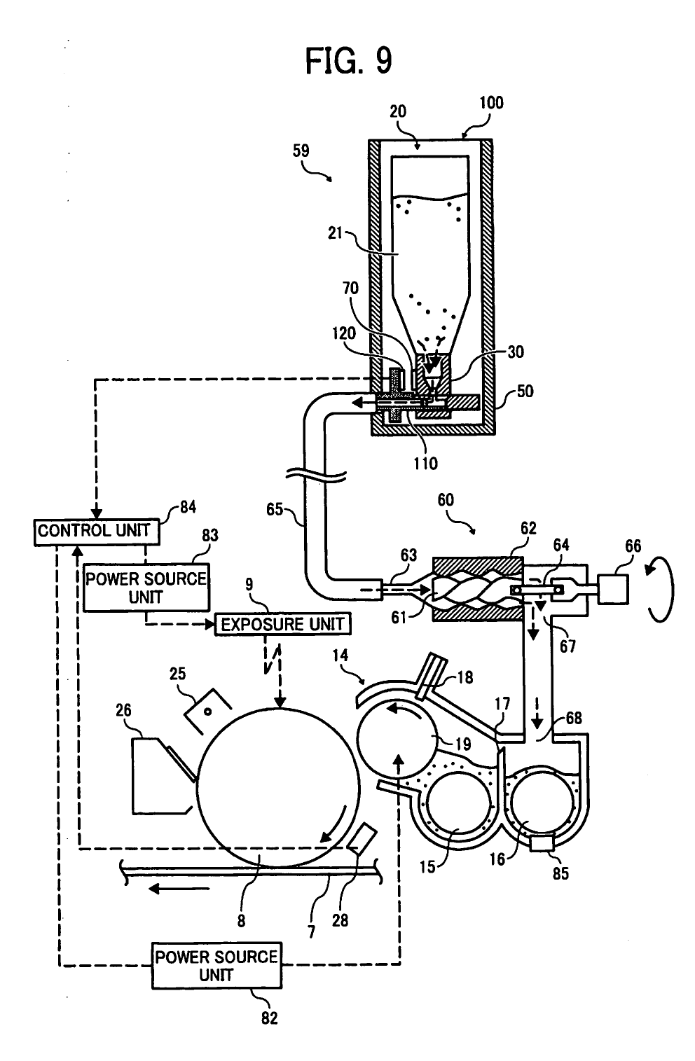

FIG. 9 shows a developer supply unit 59 which comprises a charge unit 25, an exposure unit 9, an intermediate transfer belt 7, and a cleaning unit 26 in addition to that in FIG. 3. It also comprises a toner amount sensor 28, a control unit 84, and power source units 82, 83, which will be described later in detail. Broken arrows in the drawing indicate signal flow between these units and applied bias voltage.

The developer cartridge 20 according to the present embodiment contains toner only, and supplies it in accordance with consumption. Because of this, it does not need to comprise the discharge port 81 as a developer discharge unit. However, it does need to comprise the discharge port when the present embodiment is applied to the premix developer replenishing system in the first embodiment.

Further, in the present embodiment coloring degree of toner to be contained in the developer cartridge 20 is measured in the manufacture process of the toner. Obtained data on the coloring degree of toner is written to the ID chip 70 of a developer cartridge containing the toner.

Note that the developer cartridge 20 in the present embodiment has the same structure as that of the first embodiment except for containing toner only and the ID chip 70's storing the coloring degree of the toner.

Further, in the present embodiment the coloring degree stored in the ID chip 70 is that of toner in the same manufacturing lot as toner contained in the developer cartridge 20. That is, the coloring degree of toner is measured in every manufacturing lot and the measured data is stored in ID chips 70 of all developer of cartridges 20 containing the toner manufactured in the same lot. The degree coloring of toner is measured by printing monochrome solid images in toner amount of 0.400±0.005/cm² on paper (type 6000/70W by Ricoh Co., Ltd) with a color printer, “remodeled Imageo Neo C600 (by Recoh, Co., Ltd.). Then, the solid images are measured under a certain condition (light source setting: D50, 2-degree vision) with a densitometer model 938 (by X-Rite Inc.).

Such a developer cartridge 20 is mounted in the container receive portion 100 with the door 103 open as shown in FIG. 2. In coordination with closing of the door 103, the groove 36 of the cap member 30 of the developer cartridge 20 is engaged with the convex portion of the container receive portion 100 and the plug 50 (FIG. 9) inserted into the discharge port 41 is pushed by the carrier pipe 110 of the container receive portion 100. Thus, upon completion of setting the developer cartridge 20 in the container receive portion 100, the developer in the developer cartridge 20 is ready to be supplied to the develop unit 14 by the developer supply unit 59 (FIG. 9).

Here, the ID chip 70 of the developer cartridge 20 faces an antenna 120 (data read unit) provided in the container receive portion 100 (FIG. 9). The antenna 120 reads data on coloring degree of toner stored in the ID chip 70 and transmits it to the control unit 84 which corrects an amount of toner of a toner image on the photoconductor drum 8 (and/or intermediate transfer belt 7) in accordance with the read data. That is, it is possible to finely adjust an amount of toner absorbed on the photoconductor drum 8 (and/or intermediate transfer belt 7) based on the coloring degree of toner by the develop unit 14 in the develop process.

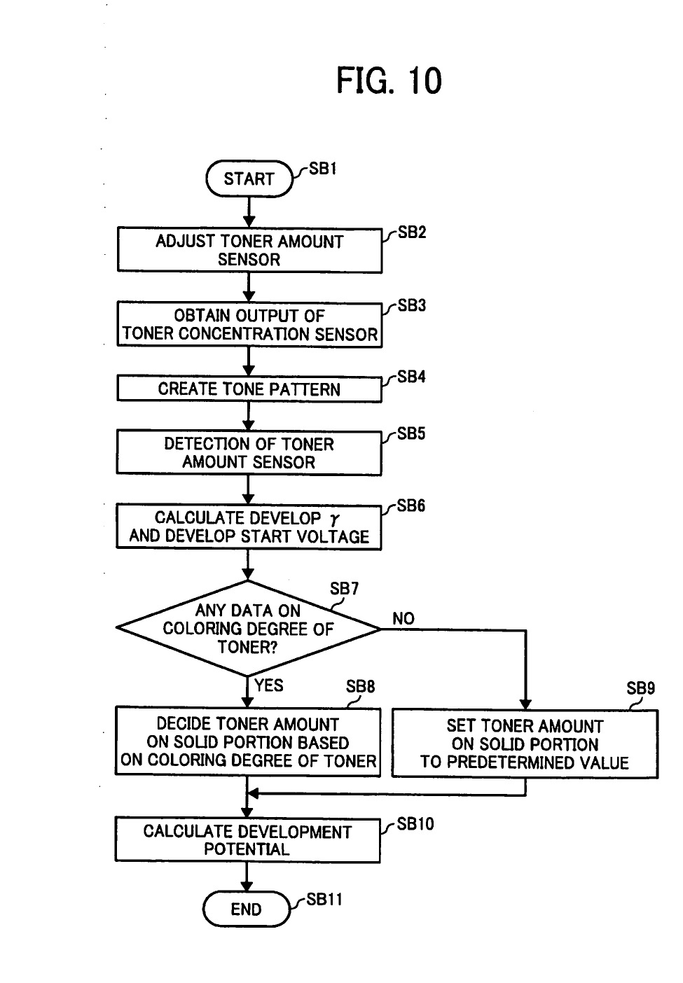

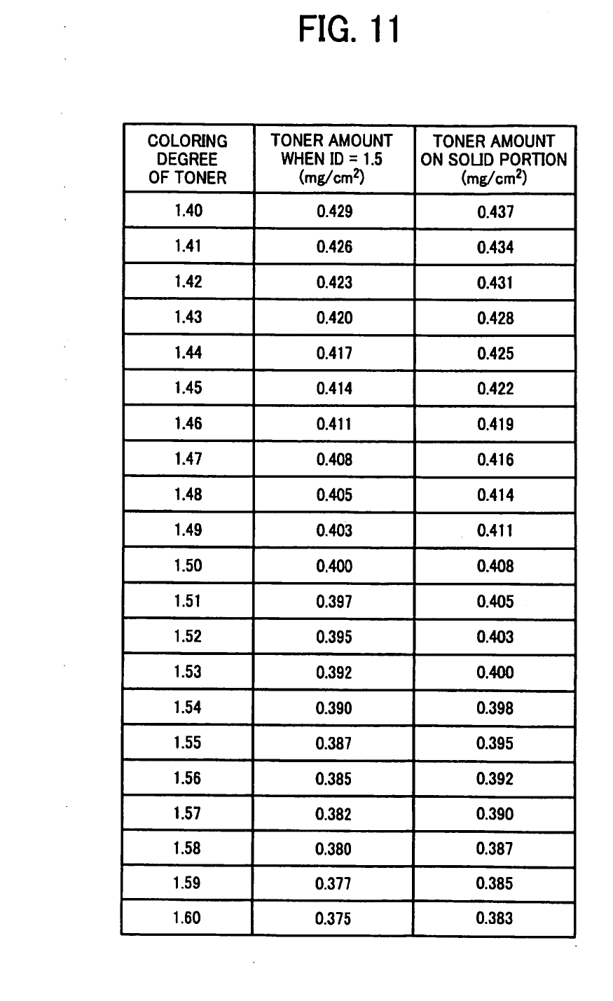

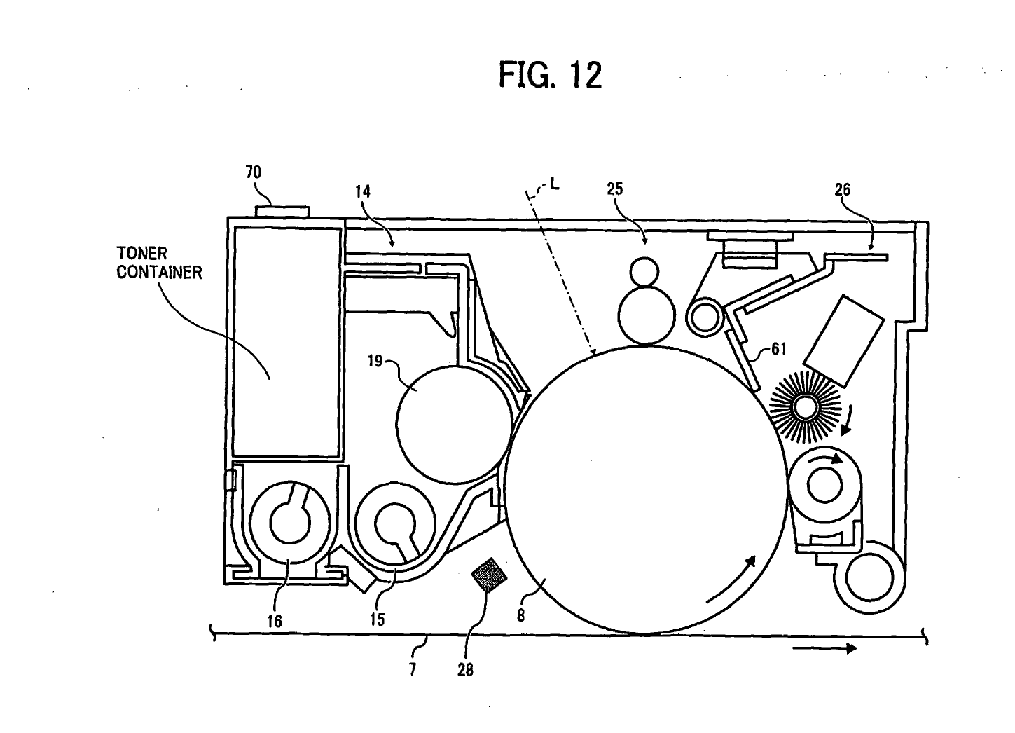

Specifically, the present embodiment is configured to include a toner amount sensor 28 (toner amount detector unit) which detects a toner amount of a toner image on the photoconductor drum 8 after the develop process and before a primary transfer process. The toner amount sensor 28 is a reflective optical sensor which optically measures a tone pattern on the photoconductor drum 8 formed at a predetermined timing (different from timing for image generation on paper) in the image generation process. The control unit 84 (toner amount changing unit) changes the toner amount of the toner image based on a detected result from the toner amount sensor 28. Also, the control unit 84 finely adjusts development potential to control the toner amount to a target value. Specifically, the control unit 84 controls a voltage of the power source unit 83 to be applied to the exposure unit 9 or controls a develop bias of the power source unit 82 for the develop unit 14 to be applied to the developer roller 19. The control unit corrects the toner amount of the toner image based on the coloring degree of toner in such a manner as to increase the toner amount when the coloring degree of toner is small and to decrease the toner amount when the coloring degree of toner is large. This enables good, stable image outputs even with a variation in the coloring degree of the toner in the developer cartridge 20. Note that a flow of the toner amount control will be described in detail later with reference to FIGS. 10, 11.

Meanwhile, for detaching the developer cartridge 20 from the container receive portion 100, the above operation for setting it is performed reversely. That is, opening of the door 103 releases the carrier pipe 110 from the cap member 30 and moves the plug 50 by a bias force of a not-shown spring to a position to close the discharge port 41. Then, with the door 103 open, the developer cartridge 20 is detached from the container receive portion 100.

The ID chip 70 can store data other than the coloring degree of toner such as toner information as toner color, manufacturing numbers (manufacturing lot) or dates, or recycle information as the number of times or dates of recycling or names of recycling firms. Moreover, the present embodiment is configured that the ID chip 70 of the developer cartridge 20 can communicate with the antenna 120 of the apparatus body 1 in a non-contact manner. However, it can be configured that the ID chip 70 communicates with the antenna 120 in a contact manner. Further, the present embodiment uses the ID chip 70 as a data storage unit, however, the present invention is not limited thereto. Any known data storage device which can read and write data is usable instead of the ID chip 70.

In the following, a toner amount control of the image formation apparatus according to the present embodiment is described with reference to FIGS. 10, 11. In FIG. 10 a toner amount control process is started at a predetermined timing at step SB1. Then, the toner amount sensor 28 (reflective optical sensor) is adjusted at step SB2 so as to have an output of 4V when receiving a positive reflected light by adjusting an emission amount of a light emitting device (LED). Such a toner amount control can be performed during a warming-up time immediately after a power-on of a power source (main switch) for the apparatus body 1 or at a timing after a predetermined number of image outputs are done. Although the toner amount sensor 28 is adjusted before start of the toner amount control, the adjustment thereof is not always needed.

At step SB3, the control unit 84 acquires a result of detection (output: Vt) of the magnetic sensor 85 of the develop unit 14. The result of detection is used for the developer supply unit 59's controlling the toner supply from the developer cartridge 20 to the develop unit 14 as described above.

At step SB4, a tone pattern is created on the photoconductor drum 8 in the above-described image generation process. This is to detect inclination of toner amount (developability) relative to a develop γ (development potential=develop bias−latent image potential). In detail, five tone patterns of 15 mm width in the main scan direction and 16 mm width in the sub scan direction are created at a position of a width direction of the photoconductor drum 8 in a scan direction with an interval of 50 mm. They are created by visualizing tone patters of latent image potentials which are formed while a charge bias and a develop bias are fixed to a certain value and an exposure amount is gradually changed.

At step SB5, the toner amount sensor 28 detects the toner amount of the tone patterns on the photoconductor drum 8. At step SB6, the develop γ and a develop start voltage are calculated from a relation between the toner amount detected by the toner amount sensor 28 and the development potential. That is, a linear function with a development potential as an X-axis and a toner amount as a Y-axis is found based on a least-square method. The inclination of the linear function represents the develop y and an intercept of X-axis represents the develop start voltage. The relation between four-color toner amounts and development potential is stored in the RAM of the control unit 84 of the apparatus body 1. Thus, a target toner amount is tentatively determined. The target toner amount refers to a toner amount of a solid portion of a toner image formed on the intermediate transfer belt 7 under a predetermined condition.

At step SB7, a determination is made on whether or not there is any data on the coloring degree of toner detected by the antenna 120 in the control unit 84. With the coloring degree data in the control unit 84, a toner amount is determined based on the data at step SB8. That is, a target toner amount on a solid portion is conclusively decided based on the coloring degree data, and the tentative target toner amount obtained at step SB6 is corrected (updated) to the conclusive target toner amount.

FIG. 11 shows a relation between coloring degree of toner (data stored in the ID chip 70) and controlled toner amount (toner amount on a solid portion). The control unit 84 (toner amount changing unit) increases a toner amount on a solid portion when the coloring degree of toner is small and decreases it when the coloring degree of toner is large. For example, at the coloring degree of toner being 1.40, the toner amount on the solid portion is corrected to 0.437 (mg/cm²) when a toner amount of 0.429 (mg/cm²) is needed to obtain a target maximum concentration (ID=1.5) as shown in FIG. 11. Likewise, at the coloring degree of toner being 1.50, the toner amount on the solid portion is corrected to 0.400 (mg/cm²) when a toner amount of 0.408 (mg/cm²) is needed to obtain a target maximum concentration (ID=1.5). At the coloring degree of toner being 1.60, the toner amount on the solid portion is corrected to 0.383 (mg/cm²) when a toner amount of 0.375 (mg/cm²) is needed to obtain a target maximum concentration (ID=1.5) as shown in FIG. 11. Note that the range of the coloring degree is set to 1.5±0.1 in FIG. 11 in line with standard tolerance of the toner used in the present embodiment.

Thus, the image formation apparatus according to the present embodiment can output images with stable, accurate color reproducibility even when a variation in the coloring degree of toner occurs due to a variation in toner manufacture condition or toner property since it corrects a toner amount value in accordance with the coloring degree of every toner used.

Further, in the prior art, an image formation apparatus controls the toner amount of a solid portion to be 0.400 (mg/cm²) so as to obtain the target maximum concentration (ID=1.5) and the toner coloring degree to be in a range of 1.50±0.05. Thereby, it reduces variations in color reproducibility and concentration due to a difference in toner manufacturing lots. On the contrary, the image formation apparatus according to the present embodiment can output images with good color reproducibility and no variation in density without increases in toner manufacture or inspection cost even when toner with coloring degree over the above range is used, since it can optimize the target toner amount of the solid portion based on the coloring degree of the toner used.

At step SB10, a development potential necessary to attain the target toner amount of the solid portion (density of solid image) at step SB8 is obtained. The target toner amount of the solid portion is attained by adjusting the develop bias using the develop y and the develop start voltage obtained at step SB6. The develop bias is an applied voltage from the power source unit 82 to the developer roller 19 and the latent image potential is an exposure amount and an applied voltage from the power source unit 83 to the exposure unit 9. At step SB11, the control process is completed.

Further, when there is no data on the coloring degree read by the antenna 120 at step SB7, the target toner amount of the solid portion is set to a predetermined value at step SB9. The control unit 84 corrects a toner amount of the solid portion based on the predetermined coloring degree. The toner coloring degree data may be unavailable when an unauthorized developer cartridge is mounted in the apparatus body 1, for example. In this case, characteristics of toner therein is unknown, so that the apparatus body 1 is operated using the predetermined coloring degree data. It is preferable to display a message on the display unit of the apparatus body 1 that toner amount control and image adjustment are not being performed based on current coloring degree data, or to transmit the message to a user's personal computer which manages printer information.

Next, the toner used in the present embodiment is described. In order to obtain fine, detailed color images, the present embodiment uses spherical polymerized toner of small particle size. The volume average particle size (Dv) of the toner is 3 to 8 μm and a ratio (Dv/Dn) of the volume average particle size and the number average particle size (Dn) is 1.00 to 1.40. The average circularity thereof is 0.93 to 1.00. Using such toner can increase resolution of images and transfer performance, achieving good image quality.

The volume average particle size of the toner can be measured with a particle distribution counter such as a Coulter counter TA-II or a Coulter multisizer II (both manufactured by Beckman Coulter, Inc.) based on a Coulter counter method. The measurement is done as follows. A surfactant (preferably, alkyl benzene sulfonates) of 0.1 to 5.0 ml is added to an electrolyctic aqueous solution of 100 to 150 ml in which about 1% NaCl aqueous solution is adjusted with a primary sodium chrolide (for example, ISOTON-II by Beckman Coulter, Inc.). Then, 2 to 20 mg of a sample is added. The aqueous solution in which the sample is suspended is dispersed for about 1 to 3 minutes by an ultrasonic distributor with an aperture of 100 μm to measure the volume of toner and the number of toner particles and calculate toner volume distribution and number distribution. The volume average particle size (D4) and number average particle size (D1) are obtained from the calculated distributions. Channels used here are 13 channels of 2.00 to 2.52 μm or less, 2.52 to 3.17 μm or less, 3.17 to 4.00 μm or less, 4.00 to 5.04 μm or less, 5.04 to 6.35 μm or less, 6.35 to 8.00 μm or less, 8.00 to 10.08 μm or less, 10.08 to 12.70 μm or less, 12.70 to 16.00 μm or less, 16.00 to 20.20 μm or less, 20.20 to 25.40 μm or less, 25.40 to 32.00 μm or less, and 32.00 to 40.30 μm or less. Toner particles of a size 2.00 μm or more and 40.30 μm or less are subjected to measurement.

Circularity A of the above toner is expressed by:

Circularity A=L₀/L

where L₀ is a boundary length of a circle with the same projected size as that of a particle image and L is a boundary length of a projected image of a particle. The circularity is an index for concavity/convexity of toner particles. A perfect spherical toner will show circularity of 1.00 and the more complex the surface shape is, the smaller the circularity is. The circularity can be measured by a flow-type particle image analyzer FPIA-2000 (manufactured by Sysmex Corporation) as follows. First, water of 100 to 150 ml without solid impurities is prepared in a container, and a surfactant agent of 0.1 to 0.5 ml as a dispersant and a sample of about 0.1 to 0.5 g are added to the water. The suspension fluid is dispersed by an ultrasonic disperser for about 1 to 3 minutes in concentration of 3,000 to 10,000 piece/μl, to measure the shapes of the toner particles with the above image analyzer.

Further, the toner used in the present embodiment is of a shape coefficient SF-1 of 100 to 180 and a shape coefficient SF-2 of 100 to 180. This allows an increased amount of the additive to be attached to one toner particle, thereby increasing an amount of inorganic particulates to protect the toner base surface form external stress as collision with carrier. Also, the toner contains fine toner powder of 2 μm or less at 30% or less. At content of the fine toner powder being over 30%, the number of inorganic particulate attached to one toner particle is reduced, increasing agglomeration of toner particles, decreasing fluidity of the developer and decreasing dispersibility of the toner in the developer when replenished. The shape coefficient SF-1 signifies a degree of roundness of a toner particle's shape. When the shape coefficient SF-1 is 100, the toner particle's shape will be a perfect sphere. The larger the SF-1 is, the more unshaped the toner shape is. The SF-1 is expressed by the following equation:

SF-1={(MXLNG)²/AREA}×(100π/4)

where MXLNG is a maximum length of a toner shape projected onto a two-dimensional plane and AREA is an area of the toner shape. The shape coefficient SF-2 signifies a ratio of concavity and convexity. There is no unevenness on the surface of the toner when the shape coefficient SF-2 is 100. The larger the SF-2 is, the more obvious the unevenness is. The SF-w is expressed by the following equation:

SF-2={(PERI)²/AREA}×(100π/4)

where a circumferential length of a toner shape projected onto a two-dimensional plane and AREA is an area of the toner shape. The shape coefficients are measured, specifically, by taking a picture of the toner with a scan-type electron microscope S-800 (by Hitachi Limited) and inputting data on the picture to an image analyzer LUSEX3 (by Nireco Corporation) for analytical computation.

Moreover, in the present embodiment the toner used is of a substantially spherical shape. Assuming that the shape of toner is defined by a long axis r1, a short axis r2, and a thickness r3 (r1≧r2≧r3), the ratio of the long axis to the short axis (r2/r1) is set to 0.5 to 1.0 and the ratio of the thickness to the short axis (r3/r2) is set to 0.7 to 1.0. At the ratio of the long axis to the short axis (r2/r1) being less than 0.5, the toner is no longer spherical, decreasing dot reproducibility and transfer efficiency to result in no image outputs with good quality. Also, at the ratio of the thickness to the short axis (r3/r2) being less than 0.7, the toner will be almost flattened, and cannot achieve high transfer rate. In contrast, at the ratio (r3/r2) being 1.0, the toner can be a rotator with the long axis as a rotation axis, improving toner fluidity.

The shape (long axis r1, short axis r2, thickness r3) of the toner is measured in the following manner. First, toner is dispersed evenly on a smooth surface. Then, 100 toner particles thereof is enlarged at 500-fold magnification with a color laser microscope VK-8500 (by KEYENCE Corporation) to measure the long axis r1 (μm), short axis r2 (μm), and thickness r3 (μm) of each of the 100 particles and to determine r1, r2, r3 from calculated average values.

Furthermore, the toner used in the present embodiment is produced through bridge reaction and/or elongation reaction of a liquid toner material in aqueous solvent. Here, the liquid toner material is obtained by dispersing polyester prepolymer including an functional group having at least nitrogen atom, polyester, a coloring agent, and a release agent in organic solvent. In the following, toner constituents and a toner manufacturing method are described in detail.

### (Polyester)

Polyester is acquired by polycondensation of polyol compound and polycarboxylic acid compound (PC). Polyol compound (PO) includes diol (DIO) and polyols three or more hydroxyl groups (TO). It is preferable to use (DIO) alone, or a mixture of (DIO) and a small amount of (TO). Diols (DIO) include alkylene glycols(ethylene glycol, 1,2-propylene glycol, 1,3-propylene glycol, 1,4-butane diol, 1,6-hexane diol, etc.); alkylene ether glycols (diethylene glycol, triethylene glycol, dipropylene glycol, polyethylene glycol, polypropylene glycol polytetramethylene ether glycol, etc.); alicyclic diols(1,4-cyclohexane dimethanol, hydrogenated bisphenol A, etc.); bisphenols (bisphenol A, bisphenol F, bisphenol S, etc.); adducts of the aforementioned alicyclic diols with alkylene oxides (ethylene oxide, propylene oxide, butylene oxide, etc.); adducts of the aforementioned bisphenols with alkylene oxides (ethylene oxide, propylene oxide, butylene oxide, etc.); etc. Among these, alkylene glycols having 2 to 12 carbon atoms and adducts of bisphenols with alkylene oxides are preferred, and particularly preferred are adducts of bisphenols with alkylene oxides and a mixture thereof with alkylene glycols having 2 to 12 carbon atoms. Polyols having three or more hydroxyl groups (TO) include polyhydric aliphatic alcohols having 3 to 8 or more hydroxyl groups (glycerin, trimethylolethane, trimethylolpropane, pentaerythritol, sorbitol, etc.); phenols having 3 or more hydroxyl groups (trisphenol PA, phenol novolac, cresol novolac, etc.); adducts of the aforementioned polyhydric phenols having 3 or more hydroxyl groups with alkylene oxides; etc.

Polycarboxylic acids (PC) include dicarboxylic acids (DIC), polycarboxylic acids having three or more carboxyl groups (TC), or the like. It is preferable to use (DIC) alone, or a mixture of (DIC) and a small amount of (TC). Dicarboxylic acids (DIC) include alkylene dicarboxylic acids (succinic acid, adipic acid, sebacic acid, etc.); alkenylene dicarboxylic acids (maleic acid, fumaric acid, etc.); aromatic dicarboxylic acids (phthalic acid, isophthalic acid, terephthalic acid, naphthalene dicarboxylic acid, etc.); or the like. Among these, alkenylene dicarboxylic acids having 4 to 20 carbon atoms and aromatic dicarboxylic acids having 8 to 20 carbon atoms are preferable. Polycarboxylic acids having three or more carboxyl groups (TC) include aromatic polycarboxylic acids having 9 to 20 carbon atoms (trimellitic acid, pyromellitic acid, etc.). Note that polycarboxylic acids (PC) may be replaced with an acid anhydride or a lower alkyl ester (methyl ester, ethyl ester, isopropyl ester, or the like) of the above-described carboxylic acids to be reacted with polyols (PO).

The ratio of a polyol (PO) to a polycarboxylic acid (PC), by the equivalent ratio of hydroxyl groups (OH) to carboxyl groups (COOH), [OH]/[COOH], is typically 2/1 to 1/1, preferably 1.5/1 to 1/1, more preferably 1.3/1 to 1.02/1. In the polycondensation, polyol (PO) and polycarboxylic acid (PC) are heated under presence of a known ester catalyst such as tetra butoxy titanate or dibutyltine oxide at 150 to 280° C. And, generated water is removed with a decreased pressure when necessary to obtain polyester having a hydroxyl group. Preferably, the hydroxyl group value thereof is 5 or more and the acid number thereof is generally 1 to 30, preferably 5 to 20. Polyester having acid number is likely to have a negative charge and makes affinity of toner for paper better when fusing, to thereby improve toner fusibility at low temperature. However, with the acid number being over 30, chargeability of toner may be unstabled, especially when an environmental change occurs. The weight average molecular weight of polyester is 10,000 to 400,000, preferably 20,000 to 200,000. With that being less than 10,000, toner offset resistance will be unpreferably decreased while with that being over 400,000, toner fusibility at low temperature will be decreased.

Urea modified polyester can be used in addition to the above unmodified polyester generated by polycondensation. The urea modified polyester is obtained by reaction of a calboxyl group or a hydroxyl group of polyester with a polyisocyanate (PIC) compound to obtain polyester prepolymer (A) having an isocyanate group and by reaction of the polyester prepolymer (A) and an amine class (B) to bridge and/or elongate molecular chain. Polyisocyanates (PIC) include aliphatic polyisocyanates (tetramethylene diisocyanate, hexamethylene diisocyanate, 2,6-diisocyanate methylcap memberroate, etc.); alicyclic polyisocyanates (isophorone diisocyanate, cyclohexylmethane diisocyanate, etc.); aromatic diisocyanates (tolylene diisocyanate, diphenylmethane diisocyanate, etc.); aromaticaliphaticdiisocyanates (α, α, α′, α′,-tetramethylxylene diisocyanate etc.); isocyanates; above-mentioned polyisocyanates blocked with a phenol derivative, an oxime, cap memberrolactum, or the like; and combinations of two or more of these.

The ratio of a polyisocyanate (PIC), by the equivalent ratio of isocyanate groups (NCO) to hydroxyl groups (OH) of the polyester, [NCO]/[OH], is typically 5/1 to 1/1, preferably 4/1 to 1.2/1, more preferably 2.5/1 to 1.5/1. When the ratio [NCO]/[OH] is more than 5, low-temperature fusibility is degraded. When the molar ratio of [NCO] is less than 1, the amount of urea in the modified polyester is low, thus deteriorating hot offset resistance.

The amount of polyisocyanate (PIC) component in an isocyanate group-containing polyester prepolymer (A) (containing at an end) is typically 0.5% to 40% of part weight, preferably 1% to 30% of part weight, more preferably 2% to 20% of part weight. If the amount is less than 0.5% of part weight, hot offset resistance is lowered and it is disadvantageous that heat-resistance during storage and low-temperature fusibility cannot be achieved at the same time. If the amount is more than 40% of part weight, low-temperature fusibility is degraded.

The number of isocyanate groups contained in each molecule of isocyanate group-containing polyester prepolymer (A) is typically one or more, preferably 1.5 to 3 on average, more preferably 1.8 to 2.5 on average. If it is less than one per molecule, the molecular weight of the urea modified polyester is reduced, and hot offset resistance is degraded.

Next, amines (B) to be reacted with polyester prepolymers (A) include diamines (B1), polyamines having 3 or more amino groups (B2), amino alcohols (B3), amino mercap membertans (B4), amino acids (B5), derivatives of B1 to B5 in which the amino groups are blocked (B6), etc.

Diamines (B1) include aromatic diamines (phenylene diamine, diethyltoluene diamine, 4,4′-diaminodiphenylmethane, etc.); alicyclic diamines (4,4′-diamino-3,3′-dimethyldicyclohexylmethane, diaminocyclohexane, isophoronediamine, etc.); aliphatic diamines (ethylenediamine, tetramethylenediamine, hexamethylenediamine, etc.); etc. Polyamines having three or more amino groups (B2) include diethylenetriamine, triethylenetetramine, etc. Amino alcohols (B3) include ethanolamine, hydroxyethylaniline, etc. Amino mercap membertans (B4) include aminoethyl mercap membertan, aminopropyl mercap membertan, etc. Amino acids (B5) include amino propionic acid, aminocap memberroic acid, etc. The aforementioned derivatives of B1 to B5 in which the amino groups are blocked (B6) include ketimine compounds that are obtained from amines of B1 to B5 and ketones (acetone, methylethylketone, methylisobutylketone, etc.), and oxazolidine compounds, etc. Among these amines (B), B1 and a mixture of B1 and a small amount of B2 are preferable.

The ratio of amines (B) by the equivalent ratio of isocyanate groups [NCO] in the isocyanate group-containing polyester prepolymer (A) to amino groups [NHx] in the amine (B), which is [NCO]/[NHx], is typically 1/2 to 2/1, preferably 1.5/1 to 1/1.5, more preferably 1.2/1 to 1/1.2. If the ratio [NCO]/[NHx] is over 2 or less than 1/2 , the molecular weight of the urea modified polyester will be low and its hot offset resistance will be degraded.

Moreover, the urea modified polyester may contain urethane bonds and urea bonds. The mol ratio of the urea bond content to the urethane bond content is normally 100/0 to 10/90, preferably 80/20 to 20/80, and most preferably, 60/40 to 30/70. If the urea bond mol ratio is less than 10%, the hot offset resistance will be degraded.

The urea modified polyester is produced by a one shot method or a prepolymer method. Polyol (PO) and polycarboxylic acid (PC) are heated under presence of a known ester catalyst such as tetra butoxy titanate or dibutyltine oxide at 150 to 280° C. And, generated water is removed with a decreased pressure when necessary to obtain polyester having a hydroxyl group. Then, at temperature of 40 to 140° C., the polyester is reacted with polyisocyanate (PIC) to obtain polyester prepolymer (A) having an isocyanate group, and then the polyester prepolymer (A) is reacted with an amine class (B) at temperature of 0 to 140° C. to obtain urea modified polyester.

A solvent can be used for reaction of (PIC), and (A) and (B) when necessary. Usable solvents are ones inactive to isocyanete (PIC) as aromatic solvents such as toluene and xylene, ketones as acetone, methylethyl ketone, or methylisobutyl ketone, esters as ethyl acetate, amides as dimethylformamide, dimethylacetamide, and ether as tetrahydrofurane.

It is possible to obtain the modified polyester by using a reaction inhibitor as necessary through the elongation or bridge reaction between the polyester prepolymer (A) and the amines(B) and to adjust the molecular weight of the urea modified polyester obtained. The reaction inhibitor is for example Monoamine (diethylamine, dibutylamine, butylamine, laurylamine, etc.) blocked monoamines (ketimine compounds), or the like.

The weight average molecular weight of the urea modified polyester is typically 10,000 or more, preferably from 20,000 to 10,000,000, and most preferably from 30,000 to 1,000,000. With that less than 10,000, the hot offset resistance deteriorates. The number average molecular of the urea modulated polyester is not limited to a particular value when used with the unmodified polyester. It may be one easily obtained as the aforementioned weight average molecular weight. When used alone, the number average molecular weight thereof is normally 2,000 or 15,000, preferably from 2,000 to 10,000, and more preferably from 2,000 to 8,000. With that over 20,000, the low temperature fusibility and luster when used in full-color devices deteriorate.

Co-use of the urea modified polyester and the unmodified polyester is preferable to use of the urea modified polyester alone since it can improves low-temperature fusibility and luster of toner when used in a full-color image formation apparatus. The unmodified polyester can include modified polyester by chemical binding other than urea binding. It is preferable in terms of the low-temperature fusibility and hot offset resistance that the urea modified polyester and the unmodified polyester form a mixture that is at least partially compatible. Therefore, it is preferred that their polyester components have similar compositions. The weight ratio of the urea modified polyester and the unmodified polyester is typically 5/95 to 80/20, preferably 5/95 to 30/70, more preferably 5/95 to 25/75, and most preferably 7/93 to 20/80. When the weight ratio of the urea modified polyester is less than 5%, toner hot offset resistance is degraded, so that toner heat-resistance and low-temperature fusibility cannot be satisfied simultaneously.

The glass transition temperature (Tg) of binder resins including urea modified and un modified polyesters is typically from 45 to 65° C., preferably 45 to 60° C. When it is lower than 45° C., toner heat resistance during storage is degraded, and when higher than 65° C., sufficient low-temperature fusibility cannot be attained. Because urea modified polyesters are prone to stay on the surface of the toner base particles obtained, the toner according to the present embodiment exhibits better heat-resistance during storage than well-known polyester toners, even with the binder resin of a low glass transition temperature.

### (Colorant)

All of known dyes and pigments are used for the colorants. The examples include carbon black, nigrosine dyes, iron black, Naphthol Yellow S, Hansa Yellow (10G, 5G and G), cadmium yellow, yellow iron oxide, yellow ocher, chrome yellow, titanium yellow, polyazo yellow, oil yellow, Hansa Yellow (GR, A, RN and R), Pigment Yellow L, Benzidine Yellow (G and GR), Permanent Yellow (NCG), Vulcan Fast Yellow (5G and R), tartrazine lake, quinoline yellow lake, Anthrazane Yellow BGL, and iso-indolinone yellow, colcothar, red lead, vermilion lead, cadmium red, cadmium-mercury red, antimony red, Permanent Red 4R, para-nitraniline red, Fire Red, para-chloro-ortho-nitroaniline red, Lithol Fast Scarlet G, Brilliant Fast Scarlet, Brilliant Carmine BS, Permanent Red (F2R, F4R, FRL, FRLL and F4RH), Fast Scarlet VD, Vulcan Fast Rubine B, Brilliant Scarlet G, Lithol Rubine GX, Permanent Red (F5R), Brilliant Carmine 6B, Pigment Scarlet 3B, Bordeaux 5B, Toluidine Maroon, Permanent Bordeaux F2K, Helio Bordeaux BL, Bordeaux 10B, BON Maroon Light, BON Maroon Medium, eosine lake, Rodamine Lake B, Rodamine Lake Y, alizarin lake, Thioindigo Red B, Thioindigo Maroon, oil red, quinacridon red, pyrazolone red, polyazo red, chromium vermilion, benzidine orange, perinone orange and oil orange, cobalt blue, Cerulean Blue, alkali blue lake, peacock blue lake, Victoria Blue Lake, metal-free phthalocyanine blue, phthalocyanine blue, Fast Sky-Blue, Indanthrene Blue (RS and BC), indigo, Prussian Blue, ultramarine blue, anthraquinone blue, Fast Violet B, methyl violet lake, cobalt violet, manganese violet, dioxane violet, anthraquinone violet, chromium green, zinc green, chromium oxide, Viridian, emerald green, Pigment Green B, Naphthol Green B, green gold, acid green lake, Malachite Green Lake, phthalocyanine green and anthraquinone green, titania oxide, zinc oxide, lithopone, etc. These colorants can be used alone or in combination, and the contents of the colorants relative to the toner is generally 1-15% of part weight, preferably 3-10% of part weight.

These colorants can be combined with resins and used for a master batch. Binder resins used for manufacture of a master batch or being mixed with a master batch include, for example, polymers of styrene or substituted styrenes such as polystyrene, poly p-chlorostyrene, polyvinyl toluene, etc., or copolymers thereof with vinyl compound; polymethylmethacrylate, polybutylmethacrylate, polyvinyl chloride, polyvinyl acetate, polyethylene, polypropylene, polyester, epoxy resins, epoxy polyol resins, polyurethanes, polyamides, polyvinyl butyral, polyacrylic resins, rosin, modified rosin, terpene resin, aliphatic or alicyclic hydrocarbon resins, aromatic petroleum resins, chlorinated paraffin, paraffin wax, etc. These may be used either alone or in combination.

### (Charge Control Agent)

Any well-known charge control agent may be used, for example, negrosine dyes, triphenylmethane dyes, chrome-containing metal complex dyes, molybdic acid chelate dyes, rhodamine dyes, alkoxy amines, quaternary ammonium salts (including fluorinated quaternary ammonium salts), alkyl amides, phosphorus and its compounds, tungsten and its compounds, fluorine activating agents, metal salicilates, metal salts of salicylic acid derivatives, etc. Specific examples are Bontron 03 as the negrosine dye, Bontron P-51 as the quaternary ammonium salt, Bontron S-34 as the alloy metal azo dye, oxynaphthoic acid metal complex E-82, the salicylic acid metal complex E-84, the phenolic condensate E-89 (manufactured by Orient Chemical Industries), the quaternary ammonium salt molybdenum complexes TP-302, TP-415 (manufactured by Hodogaya Chemical Industries), the quaternary ammonium salt Copy Charge PSY VP2038, the triphenylmethane derivative Copy Blue PR, the quaternary ammonium salts Copy Charge NEG VP2036 and Copy Charge NX VP434 (manufactured by Hoechst), LRA-901, LR-147 as the boron complex (manufactured by Japan Carlit Co., Ltd.), copper phthalocyanine, perylene, quinacridone, azo pigments, and other polymer compounds containing a functional groups such as sulfonic acid group, carboxyl group, quaternary ammonium salt, etc. Of these, substances that control the toner by negative polarity are particularly preferable.

The amount of the charge control agent is determined according to a type of the binder resin, the presence or absence of additives used if necessary, and toner manufacturing method including dispersion method. It is not primarily limited to a certain amount; however, a preferable range thereof should be 0.1 to 10 weight parts relative to 100 weight parts of the binder resin, and more preferably, 0.2 to 5 weight parts. The use of over 10 weight parts of the charge control agent makes the chargeability of the toner too large, causing an increase in electrostatic absorption between the toner and the developing roller, a reduction in the fluidity of the developer, and a reduction in the density of the image.

### (Releasing Agents)

For the releasing agent, waxes with a melting point of 50 to 120° C. are preferable, since they effectively work as the releasing agent between the fuse roller and the interface of the toner during dispersion from the binder resin and achieve an anti-offset effect at high temperature without coating the releasing agent such as oil on the fuse roller. The examples of such waxes are as follows.

Waxes are exemplified by vegetable waxes such as carnauba wax, cotton wax, tree wax, and rice wax; animal wax such as beeswax and lanolin; mineral wax such as ozokerite and ceresin; and petroleum wax such as paraffin, microcrystalline, and petrolatum. In addition to these natural waxes, there are synthetic hydrocarbon waxes such as Fischer Tropsch wax and polyethylene wax; and synthetic waxes such as esters, ketones, and ethers. Other examples are fatty acid amides such as 12-hydroxystearic acid amide, stearic acid amide, anhydrous phthalic acid amide, and chlorinated hydrocarbon; and crystalline polymers having a long-chained alkyl group, which are crystalline polymer resins of low molecular weight, and homopolymers or copolymers (for example, n-stearyl acrylate-ethyl methacrylate copolymer, etc.) of polyacrylates such as poly-n-stearyl methacrylate and poly-n-lauryl methacrylate.

The charge control agent and release agent can be melted and kneaded with the master batch and binder resin, or added to the organic solvent at the fusion and dispersion.

### (Additives)

Inorganic microparticles are preferably used for the additives to support the fluidity, developability, and chargeability of the toner particles. The primary particle size should be preferably 5×10⁻³ to 2 μm, more preferably 5×10⁻³ to 0.5 μm. Specific surface area according to BET method should be preferably 20 to 500 m²/g. The ratio of the inorganic microparticles to the toner should be preferably 0.01 to 5 wt %, more preferably 0.01 to 2.0 wt %.

Examples of inorganic particulates include silica, alumina, titanium oxide, barium titanate, magnesium titanate, calcium titanate, strontium titanate, zinc oxide, tin oxide, silica sand, clay, mica, silicic pyroclastic rock, diatomite, chromium oxide, cerium oxide, red iron oxide, antimony trioxide, magnesium oxide, zirconium oxide, barium sulfate, barium carbonate, calcium carbonate, silicon carbide, silicon nitride, etc. Among them, preferably, hydrophobic silica microparticles and hydrophobic titanium oxide microparticles are combined for fluid additives. Specifically, both of the particulates with mean particle size of 5×10−2 μm or less are used in agitated mixture in the develop unit to obtain a desired charge level, electrostatic performance and van der Waals binding to the toner are tremendously improved. Therefore, it is made possible to attain images with good image quality without flaring and reduce the amount of the remnant toner after the transfer.

The titanium oxide microparticles have good qualities in terms of environmental stability and stable image density; however, they tend to deteriorate a charge rising characteristic. Therefore, when the titanium oxide microparticles are added to the toner with a larger amount than the silicap memberarticulate, such deterioration effect will be considerable. However, maintaining the additive amount of the titanium oxide microparticules in a range of 0.3 to 1.5 wt % makes it possible to obtain a desirable charge rising characteristic, whereby images with good stable quality can be obtained even at the time of repetitive copying, for example.

Next, the toner manufacturing method will be described. Herein, a description will be made on preferable methods as examples; however, the method should not be limited thereto.
(1) Toner solution is prepared by dispersing colorants, unmodified polyester, isocyanate group-containing polyester prepolymer, and a releasing agent in an organic solvent. Preferable organic solvents should be volatile with a boiling point of less than 100° C. since they are easily removed after the toner base particles are formed. Specifically, examples are toluene, xylene, benzene, carbon tetrachloride, methylene chloride, 1,2-dichloroethane, 1,1,2-trichloroethane, trichloroethylene, chloroform, monochloro benzene, dichloroethylidene, methyl acetate, ethyl acetate, methyl ethyl ketone, methyl isobutyl ketone, etc., and they can be used alone or in combinations of two or more kinds. Particularly, aromatic solvents such as toluene and xylene, and halogenated hydrocarbons such as methylene chloride, 1,2-dichloroethane, chloroform, and carbon tetrachloride are preferable. The amount of the organic solvent to be used is typically 0 to 300 weight parts relative to 100 weight parts of polyester prepolymer, preferably 0 to 100 weight parts, and more preferably 25 to 70 weight parts.
(2) The toner solution is emulsified in an aqueous medium with a surfactant and resin microparticles. The aqueous medium can be water alone or water containing an organic solvent such as alcohol (methanol, isopropyl alcohol, ethylene glycol, etc.), dimethylformamide, tetrahydrofuran, cellusolves (methyl cellusolve, etc.), and lower ketones (acetone, methyl ethyl ketone, etc.). The amount of the aqueous medium to be used relative to 100 weight parts of toner solution is typically 50 to 2,000 weight parts, and preferably 100 to 1,000 weight parts. When the amount thereof is less than 50 weight parts, the toner solution cannot be dispersed enough to obtain toner particles of a predetermined particle size, while with that of over 20,000 weight parts, cost efficiency is not good.

Also, to keep the dispersion in the aqueous medium in good condition, dispersion agents such as surfactant or resin can be added thereto appropriately. Examples of surfactants include anionic surfactants such as alkyl benzene sulfonates, α-olefin sulfonates, phosphoric acid esters, or the like; amine salts such as alkylamine salts, aminoalcohol fatty acid derivatives, polyamine fatty acid derivatives, imidazoline, or the like; quaternary ammonium salt cationic surfactants such as alkyltrimethyl ammonium salts, dialkyl dimethyl ammonium salts, alkyl dimethyl benzyl ammonium salts, pyridinium salts, alkyl isoquinolinium salts, benzetonium chloride, or the like; non-ionic surfactants such as fatty acid amide derivatives, polyvalent alcohol derivatives, or the like; amphoteric surfactants such as alanine, dodecyldi(aminoethyl)glycine, di(octylaminoethyl)glycine, N-alkyl-N, N-dimethylammoniumbetaine, etc.

Further, the use of a very small amount of a surfactant having a fluoroalkyl group can achieve a great effect. Examples of anionic surfactants having the fluoro alkyl group are preferably fluoroalkyl carboxylic acids having 2 to 10 carbon atoms and metal salts thereof, disodium perfluorooctane sulfonylglutamate, sodium 3-[ω-fluoroalkyl (C6 to C11)oxy]-1-alkyl (C3 to C4)sulfonate, sodium 3-[ω-fluoroalkanoyl (C6 to C8)-N-ethylamino]-1-propane sulfonate, fluoroalkyl (C11 to C20) carboxylic acids and metal salts thereof, perfluoroalkyl carboxylic acids (C7 to C13) and metal salts thereof, perfluoroalkyl (C4 to C12) sulfonates and metal salts thereof, perfluorooctanesulfonic acid diethanolamide, N-propyl-N-(2-hydroxyethyl)perfluorooctane sulfonamide, perfluoroalkyl (C6 to C10) sulfonamide propyltrimethylammonium salt, perfluoroalkyl (C6 to C10)-N-ethylsulfonyl glycine salt, monoperfluoroalkyl (C6 to C16) ethyl phosphoric acid ester, etc.

Available commercial products are, for example, Surflon S-111, S-112, S-113 (manufactured by Asahi Glass Co. Ltd), Fluorad FC-93, FC-95, FC-98, FC-129 (Sumitomo 3M Limited), Unidyne DS-101, DS-102 (Daikin Industries Ltd.), Megafack F-1110, F-120, F-113, F-191, F-812, F-833 (manufactured by Dainippon Ink And Chemicals, Incorporated), Ekutop EF-102 to 105, 112, 123A, 123B, 306A, 501, 201, 204 (manufactured by Tohkem Products Corporation), Ftergent F-100, F150 (manufactured by Neos Company Limted).

The examples of cationic surfactants are primary or secondary fatty series or secondary amine acids having a fluoroalkyl group, quaternary ammonium salts of fatty acids such as perfluoroalkyl (C6 to C10) sulfonamide propyltrimethylammonium salt, or the like; benzalkonium salts, benzetonium chloride, pyridinium chloride and imidazolinium salts. Available commercial products are, for example, Surflon S-121 (manufactured by Asahi Glass Co., Ltd.), Fluorad FC-135 (manufactured by Sumitomo 3M, Co., Ltd.). Unidyne DS-202 (manufactured by Daikin Industries, Ltd.), Megafack F-150 and F-824 (manufactured by Dainippon Ink and Chemicals Incorporated), Ekutop EF-132 (manufactured by Tochem Products Corporation), Ftergent F-300 (manufactured by NEOS Company Limted), etc.

Resin microparticles are added in order to stabilize the toner base particles that are formed in the aqueous medium. For this purpose, microparticles are added so as to have the covering rate on the surface of the toner base particles preferably at 10 to 90%. They are, for example, polymethylmethacrlate micro particles 1 μm and 3 μm, polystyrene microparticles 0.5 μm and 2 μm, poly(styrene-acrylonitryl) microparticles 1 μm. Available commercial products are, for example, PB-200H (manufactured by Kao Corporation), SGP (manufactured by Soken Co. Ltd), technopolymer SB (manufactured by Sekisui Plastics O. Ltd), SGP-3G (manufactured by Soken Co. Ltd.), and Micropar (manufactured by Sekisui Fine Chemicals Co. Ltd.). Inorganic compound dispersion agents such as tricalcium phosphate, calcium carbonate, titanium oxide, colloidal silica, hydroxyapatite, or the like can be also used.

The dispersion agents usable with the aforementioned resin microparticles and inorganic compound dispersion agents are ones in which dispersion droplets are stabilized by a high polymer protecting colloid. Examples are acids such as acrylic acid, methacrylic acid, α-cyanoacrylic acid, α-cyanomethacrylic acid, itaconic acid, crotonic acid, fumaric acid, maleic acid, maleic anhydride, or the like; (meth)acrylic monomers which contain hydroxyl groups such as β-hydroxyethyl acrylic acid, β-hydroxyethyl methacrylic acid, β-hydroxypropyl acrylic acid, β-hydroxypropyl methacrylic acid, γ-hydroxypropyl acrylic acid, γ-hydroxypropyl methacrylic acid, 3-chloro-2-hydroxypropyl acrylic acid, 3-chloro-2-hydroxypropyl methacrylic acid, diethylene glycol monoacrylic acid ester, diethylene glycol monomethacrylic acid ester, glycerine monoacrylic acid ester, glycerine monomethacrylic acid ester, N-methylolacrylamide, N-methylolmethacrylamide, or the like; vinyl alcohol or ether of vinyl alcohol such as vinyl methyl ether, vinyl ethyl ether and vinyl propyl ether, etc., esters of compounds containing a carboxylic group with vinyl alcohol such as vinyl acetate, vinyl propionate and vinyl butyrate, etc., acrylamide, methacrylamide, diacetone acrylamide, methylol compounds thereof, or the like; acid chlorides such as acrylic acid chloride and methacrylic acid chloride, homopolymers and copolymers containing a nitrogen compound or heterocyclic ring such as vinyl pyridine, vinyl pyrolidone, vinyl imidazole, ethyleneimine, or the like; polyoxyethylene compounds such as polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester, polyoxyethylene nonyl phenyl ester, or the like; celluloses such as methyl cellulose, hydoxyethyl cellulose, hydroxypropyl cellulose, or the like, etc.

There is no particular limitation to the dispersion method which may employ any known dispersion device using such as low speed shear, high speed shear, friction, high-pressure jet, ultrasound, or the like. Among them, the high speed shear dispersion device is preferred to obtain dispersed particles having a diameter of 2 to 20 μm. A rotation speed thereof is not particularly limited, however, it is typically 1,000 to 30,000 rpm, and preferably 5,000 to 20,000 rpm. Nor particularly limited is dispersion time, however in a batch process, it is typically 0.1 to 5 minutes. The temperature at the dispersion is typically 0 to 150 ° C. (under pressure), preferably 40 to 98° C.
(3) Concurrently with the preparation of the emulsifying solution, amines (B) are added, and reacted with the isocyanate base-containing polyester prepolymer (A). This reaction occurs in conjunction with molecular chain elongation and/or bridge reaction. The reaction time may be determined according to the reactivity of the combination of the isocyanate group in the polyester prepolymer (A) and the amine (B), and it is typically 10 minutes to 40 hours, and is preferably 2 to 24 hours. The reaction temperature is typically 0 to 150° C., and preferably 40 to 98° C. A catalyst known in the art such as dibutyl tin laurate, dioctyl tin laurate may also be used if required.
(4) After completion of the reaction, toner base particles are obtained by removing the organic solvent from the emulsified dispersion (reaction product), rinsing, and drying. In order to remove the organic solvent, the temperature of the entire system is gradually raised while laminar agitation is conducted on the dispersion. When the temperature reaches in a fixed temperature range, strong agitation is conducted thereon. Thereafter, spindle-shaped toner base particles can be produced by removing the solvent. In addition, with use of substance soluble in acid and alkali such as calcium phosphate salt as a dispersion stabilizer, the calcium phosphate salt can be removed from the toner base particles by dissolving the calcium phosphate salt using an acid such as hydrochloric acid and rinsing with water, for example. It can be removed through other processes such as decomposition using enzymes.
(5) Then, toner is obtained by implanting a charge control agent in the toner base particles obtained as above and adding thereto inorganic microparticles such as silica microparticles and titanium oxide microparticles. The implantation of the charge control agent and the addition of inorganic microparticles are conducted by well-known methods using a mixer or the like, for example. Thereby, toner with a small particle size and sharp particle size distribution can be easily obtained. Further, the strong agitation in the organic solvent removal process makes it possible to adjust the shape of the particles from a sphere to a rugby ball, and also adjust the surface morphology from smooth to wrinkled.

The toner is not limited to the above-described toner, and other known toner such as oilless toner is usable. The oilless toner contains a binder resin, a colorant and a release agent. The oilless toner can be used in the fuser unit 12 having a heat roller (fuse roller) without toner attachment preventing oil coated. Although spent toner in which a releasing agent is moved onto to a carrier surface is likely to occur in the oilless toner, the premix developer replenishing system can concurrently supply toner and carrier. Because of this, it can improve resistance to the spent toner dramatically, compared to supplying toner only, making it possible to maintain good toner quality over a long period of time.

As described above, the developer cartridge 20 according to the present embodiment is configured to include the ID chip 70 (data storage unit) which stores data on the coloring degree of toner. Because of this, the image formation apparatus including the developer cartridge 20 can output images with good, stable color reproducibility irrespective of a variation in coloring degree of toner without increases in toner manufacture or inspection costs.

Moreover, the present embodiment uses a deformable bag-type inner container 21. However, the present invention is not limited thereto and applicable to other types of developer cartridges such as bottle type or box type having non-deformable, rigid walls. Such other developer cartridges can attain the same effects as those of the present embodiment by including the data storage unit storing data on the toner coloring degree.

Further, the present embodiment adopts the develop unit 14 containing a two-component developer. However, the present invention is applicable to a develop unit containing a single component developer (excluding carrier). The present invention is also applicable to a develop unit of a premix developer redesigning type which is supplied with a two-component developer from a developer cartridge and discharges extraneous developer. These develop units can achieve the same effects as that of the present embodiment by including the developer cartridge provided with the data storage unit storing data on the coloring degree of toner.

Furthermore, the present invention is applicable to a develop unit (or process cartridge integrated with a photoconductor drum, a charge unit or a cleaning unit) integrated with a develop cartridge which is detachably mounted in a body of an image formation apparatus. Such develop unit can also achieve the same effects as those of the present embodiment by including the data storage unit which stores data on the coloring degree of toner.

In the present embodiment, the toner amount sensor 28 is placed at a position opposite to the photoconductor drum 8 (downstream of a position opposite to the develop unit 14 and upstream of a position opposite to the intermediate transfer belt 7) to directly detect a toner amount of a toner image on the photoconductor drum 8 (image carrier). However, the toner amount sensor 28 can be placed at a position opposite to the intermediate transfer belt 7 to indirectly detect the toner amount of the toner image on the photoconductor drum 8. Further, it can be configured that the toner amount sensor 28 is provided at two positions, one opposite to the photoconductor drum 8 and the other opposite to the intermediate transfer belt 7 to detect the toner amount of the toner image on the photoconductor drum 8. In such configurations, the same effects as those in the present embodiment is achievable by controlling the toner amount based on detection results of the toner amount sensor.

The present invention additionally includes the following inventions.
(1) A developer cartridge comprising an inner container containing toner and detachably placed in a body of an image formation apparatus, the developer cartridge comprising a data storage unit in which data on a coloring degree of the toner in the inner container is stored.
(2) A developer cartridge according to the item (1), wherein the developer cartridge contains carrier together with the toner.
(3) An image formation apparatus comprising:

the developer cartridge according to the item (1) or (2);

an image carrier;

a develop unit which develops a latent image on the image carrier to form a toner image;

a toner amount detector unit which directly or indirectly detects a toner amount of the toner image on the image carrier;

a toner amount changing unit which changes the toner amount of the toner image on the image carrier based on a result of detection from the toner amount detector unit; and

a data read unit which reads the data stored in the data storage unit of the developer cartridge, wherein

the toner amount detector unit corrects the toner amount of the toner image on the image carrier based on the data read by the data read unit.
(4) An image formation apparatus according to the item (3), wherein the toner amount changing unit increases the toner amount when a coloring degree of the toner is low, and decreases the toner amount when the coloring degree of the toner is high.
(5) An image formation apparatus according to the item (3) or the item (4), wherein the toner amount changing unit corrects the toner amount of the toner image on the image carrier based on a predetermined coloring degree of toner when there is no data read by the data read unit.
(6) An image formation apparatus according to any one of the item 3 to the item 5, wherein the develop unit is integrated with the developer cartridge and detachably mounted in a body of the image formation apparatus.
(7) A develop unit which develops a latent image on an image carrier to form a toner image and is detachably mounted in a body of an image formation apparatus, the develop unit comprising a data storage unit in which data on a coloring degree of toner to be contained in the develop unit is stored.

Although the present invention has been described in terms of exemplary embodiments, it is not limited thereto. It should be appreciated that variations may be made in the embodiments described by persons skilled in the art without departing from the scope of the present invention as defined by the following claims. Further, the numbers, positions, and shapes of components should not be limited to those in the present embodiment, any number, position, and shape can be applied appropriately.

What is claimed is:

1. A developer cartridge containing developer made of toner and carrier and used for an image formation apparatus, the developer cartridge comprising:
an inner container containing the developer; and
a data storage unit storing data on a content rate of the carrier in the developer contained in the inner container.

2. A developer cartridge according to claim 1, wherein
in a manufacture process of the developer cartridge, the content rate of the carrier is determined in accordance with a chargeability of toner to be contained in the inner container.

3. A developer cartridge according to claim 2, wherein
in a manufacture process of the developer cartridge, the content rate of the carrier is set to a small value when the chargeability of the toner to be contained in the inner container is high while the content rate of the carrier is set to a large value when the chargeability of the toner is low.

4. A developer cartridge according to claim 2, wherein
in the manufacture process of the developer cartridge, a chargeability of toner to be contained in the inner container is set to a chargeability of toner which is manufactured in a same manufacturing lot as the toner contained in the inner container and is mixed with carrier in a predetermined manufacturing lot other than a manufacturing lot of the carrier contained in the inner container.

5. A developer cartridge according to claim 3, wherein
in the manufacture process of the developer cartridge, a chargeability of toner to be contained in the inner container is set to a chargeability of toner which is manufactured in a same manufacturing lot as the toner contained in the inner container and is mixed with carrier in a predetermined manufacturing lot other than a manufacturing lot of the carrier contained in the inner container.

6. A developer cartridge according to claim 2, wherein
in the manufacture process of the developer cartridge, a chargeability of toner to be contained in the inner container is set to a chargeability of toner which is manufactured in a same manufacturing lot as the toner contained in the inner container and is mixed with carrier in a same manufacturing lot as a manufacturing lot of the carrier contained in the inner container.

7. A developer cartridge according to claim 3, wherein
in the manufacture process of the developer cartridge, a chargeability of toner to be contained in the inner container is set to a chargeability of toner which is manufactured in a same manufacturing lot as the toner contained in the inner container and is mixed with carrier in a same manufacturing lot as a manufacturing lot of the carrier contained in the inner container.

8. An image formation apparatus comprising:
the developer cartridge according to claim 1 detachably mounted in a body of an image formation apparatus;
a develop unit which develops a latent image formed on an image carrier;
a toner concentration detector unit which directly or indirectly detects a toner concentration of a developer contained in the develop cartridge;
a developer supply unit which supplies the developer from the developer cartridge to the develop unit in accordance with a result of the detection by the toner concentration detector unit;
a developer discharge unit which discharges a part of the developer in the develop unit to outside; and
a data read unit which reads the data stored in the data storage unit.

9. An image formation apparatus according to claim 8, wherein
the developer supply unit changes an amount of the developer to be supplied from the developer cartridge to the develop unit in accordance with the data read by the data read unit.

10. An image formation apparatus according to claim 9, wherein
the developer supply unit decreases a supply of the developer when a content rate of the carrier is low and increases the supply of the developer when the content rate of the carrier is high, so as to adjust the toner concentration to be in a predetermined range.
